(19) United States
(12) Patent Application Publication
(10) Pub. No.: US 2024/0020191 A1
(43) Pub. Date: Jan. 18, 2024

(54) METHODS AND SYSTEMS FOR RESOLVING ROOT CAUSES OF PERFORMANCE PROBLEMS WITH APPLICATIONS EXECUTING IN A DATA CENTER

(71) Applicant: VMware, Inc., Palo Alto, CA (US)

(72) Inventors: Ashot Nshan Harutyunyan, Yerevan (AM); Arnak Poghosyan, Yerevan (AM); Naira Movses Grigoryan, Yerevan (AM)

(73) Assignee: VMware, Inc., Palo Alto, CA (US)

(21) Appl. No.: 17/864,220

(22) Filed: Jul. 13, 2022

(51) Int. Cl. G06F 11/07; G06F 11/34

(52) U.S. Cl. CPC G06F 11/079; G06F 11/3495; G06F 11/0721

(57) ABSTRACT

Automated methods and systems for resolving potential root causes of performance problems with applications executing in a data center are described. The automated methods use machine learning to train an inference model that relates event types recorded in metrics, log messages, and traces of an application to values of a key performance indicator (“KPI”) of the application. The methods use the trained inference model to determine which of the event types are important event types that relate to performance of the application. In response to detecting a run-time performance problem in the KPI, the methods determine which of the important event has a higher probability of being the potential root cause of the performance problem. A graphical user interface displays an alert that identifies the application as having the run-time performance problem, identity of the important event types, and at least one recommendation for remedying the performance problem.

### TECHNICAL FIELD

This disclosure is directed to identifying root causes of performance problems with applications executing in a data center.

### BACKGROUND

Electronic computing has evolved from primitive, vacuum-tube-based computer systems, initially developed during the 1940s, to modern electronic computing systems in which large numbers of multi-processor computer systems are networked together with large-capacity data-storage devices and other electronic devices to produce geographically distributed data centers that provide enormous computational bandwidths and data-storage capacities. Data centers are made possible by advances in virtualization, computer networking, distributed operating systems, data-storage appliances, computer hardware, and software technologies. In recent years, an increasing number of businesses, governments, and other organizations rent data processing services and data storage space as data center tenants. Data center tenants conduct business and provide cloud services over the internet on software platforms that are maintained and run entirely in data centers, which reduces the cost of maintaining their own centralized computing networks and hosts.

Because data centers have an enormous number of computational resources and execute thousands of computer programs, various management tools have been developed to collect performance information that can be used to aid systems administrators and data center tenants with detection of hardware and software performance problems. Management tools have been developed to aid system administrators with detection of performance problems. However, typical management tools are not able to timely troubleshoot root causes of many types of problems from the information collected. For example, a management tool may generate an alert that identifies a problem with a program or a hardware device running in the data center, but the root cause of the problem might actually be the result of a different problem occurring with hardware and/or software located elsewhere in the data center and is not identified in the alert.

Because typical management tools cannot identify the root cause of most problems occurring in a data center, the search for root causes of problems is performed by teams of engineers, such as a field engineering team, an escalation engineering team, and a research and development engineering team. Each team searches for a root cause of a problem by manually filtering metrics and log messages through different sub-teams. However, because of the enormous numbers of metrics and log messages generated each day, the troubleshooting process can take days and weeks, and in some cases months. Data center tenants cannot afford such long periods of time spent sifting through metrics and log files for a root cause of a problem. Employing teams of engineers to spend days and weeks to search for a problem is expensive and error prone. Problems with a data center tenant's applications result in downtime or slow performance of their applications, which frustrates users, damages a brand name, causes lost revenue, and in many cases can deny people access to services provided by data center tenants. Systems administrators and data center tenants seek automated methods and systems that identify root causes of problems in a data center within hours or minutes and significantly reduce the reliance on teams of engineers to troubleshoot performance problems.

### SUMMARY

This disclosure is directed to automated methods and systems for resolving potential root causes of performance problems with application executing in a data center. The automated methods are executed by an operations management server that runs in a server computer of the data center. The operations management server uses machine learning to train an inference model that relates event types recorded in metrics, log messages, and traces of the application over a historical time period to values of a key performance indicator (“KPI”) of the application. The server uses the trained inference model to determine which of the event types are important event types that relate to performance of the application. The server monitors the KPI to detect run-time performance problems with application. The term run time references to while the application is running. In response to detecting a run-time performance problem in the KPI, the server determines which of the important event has a higher probability of relating to the potential root cause of the performance problem. The server displays in a graphical user interface (“GUI”) of an electronic display device an alert that identifies the application as having the run-time performance problem, identity of the important event types that are most likely the root cause of the performance problem, and at least one recommendation for remedying the performance problem.

### DESCRIPTION OF THE DRAWINGS

FIG. 1 shows an example of a virtualization layer located above a physical data center.

FIGS. 2A-2B shows an operations management server that receives object information from various physical and virtual objects.

FIG. 3 shows an example architecture of an operations management server.

FIG. 4 shows an example of logging log messages in log files.

FIG. 5 shows an example source code of an event source.

FIG. 6 shows an example of a log write instruction.

FIG. 7 shows an example of a log message generated by the log write instruction in FIG. 6.

FIG. 8 shows a small, eight-entry portion of a log file.

FIG. 9A shown a table of examples of regular expressions designed to match particular character strings of log messages.

FIG. 9B shows a table of examples primary Grok patterns and corresponding regular expressions.

FIG. 9C shows an example of a Grok expression used to extract tokens from a log message.

FIG. 10 shows an example of generating a divergence value for a portion of a log file.

FIG. 11 shows a plot of an example sequence of consecutive divergence values computed for overlapping time windows.

FIG. 12 shows a plot of an example metric.

FIGS. 13A-13B show an example distributed application and an example application trace.

FIG. 14A shows a plot of historical values of a key performance indicator (“KPI”).

FIG. 14B is a flow diagram of computing an event type distribution of event types recorded in historical time windows of a historical period.

FIG. 15A shows an example of object information retrieved from databases in a historical time window.

FIG. 15B shows an example of forming an event type distribution from probabilities of event types that occurred in the time window.

FIG. 16 shows examples of event type distributions persisted in an event type distributions database.

FIG. 17 shows matrix representations of a parametric inference model.

FIG. 18A shows an example of partitioning a set of event type probabilities and a KPI into a training set and validating set of event type probabilities.

FIGS. 18B-18E show an example of training a parametric inference model using a backward stepwise process.

FIGS. 19A-19E show of an example of cross validation applied to an example set of event type probabilities and KPI values.

FIGS. 20A-20F show an example of determining a K-nearest neighbor regression model.

FIG. 21 shows an example of a trained parametric inference model used to compute an estimated provisional KPI.

FIG. 22 shows example of event type distributions represented in a multi-dimensional space.

FIG. 23 shows an example plot of mean square errors for a number of the estimated provisional KPIs.

FIG. 24A shows a plot of example relative importance scores for a series of event types.

FIG. 24B shows a plot of example relative importance scores rank ordered from largest to smallest.

FIG. 25A shows plots of example probabilities of event type distributions produced in historical time intervals of the historical time period.

FIG. 25B shows a plot of event type probabilities partitioned into quartiles.

FIG. 26 shows an example of structured information content of a recommendations database.

FIG. 27 shows example contents of a data table for a latency KPI of an application executing in a data center.

FIG. 28 shows an example graphical user interface (“GUI”) that displays a list of applications executing in a data center in left-hand pane.

FIG. 29 shows an example GUI that displays troubleshooting results in a data table stored in a recommendations database.

FIG. 30 is a flow diagram illustrating an example implementation of a method resolving root causes of performance problems with an application executing a data center.

FIG. 31 is a flow diagram illustrating an example implementation of the “train an inference model that relates event types recorded in metrics, log messages, and traces to KPI values in a historical time period” procedure performed in FIG. 30.

FIG. 32 is a flow diagram illustrating an example implementation of the “compute event type probabilities of event types recorded in historical time intervals of the historical time period” procedure performed in FIG. 31.

FIG. 33 is a flow diagram illustrating an example implementation of the “train an inference model based of the event type probabilities” procedure performed in FIG. 31.

FIG. 34 is a flow diagram illustrating an example implementation of the “use the trained inference model to determine which of the event types are important event types that relate to performance of the application” procedure performed in FIG. 30.

FIG. 35 is a flow diagram illustrating an example implementation of the “determine which important event types occur in a run-time interval with an atypically high probability or an atypically low probability” procedure performed in FIG. 30.

FIG. 36 shows an example architecture of a computer system that performs an automated processes for resolving root causes of performance problems with an application executing a data center.

### DETAILED DESCRIPTION

This disclosure presents automated methods and systems for identifying and resolving performance problems with applications executing in a data center object. Metrics, log messages, traces, and key performance indicators are described in a first subsection. Automated methods and system for identifying and resolving root causes of performance problems with applications running in a data center are described in a second subsection.

### Metrics, Log Messages, and Traces

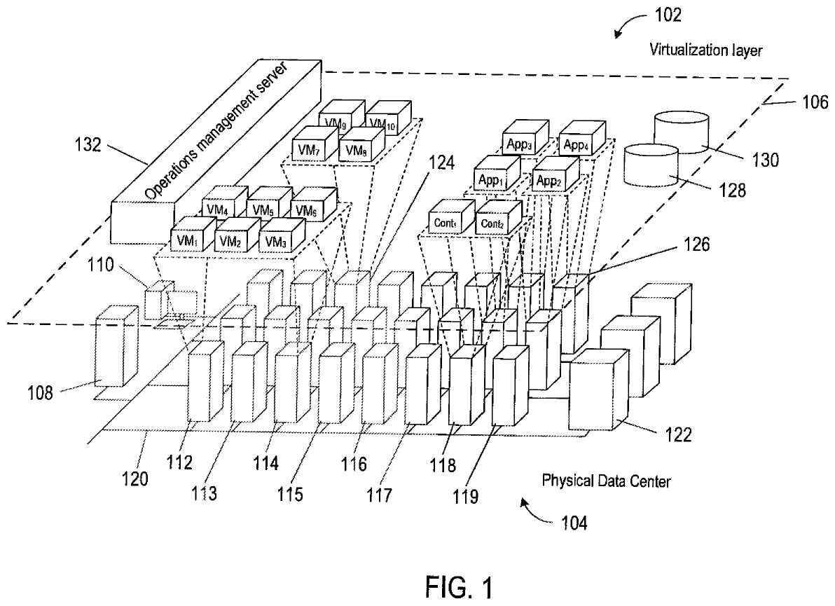

FIG. 1 shows an example of a virtualization layer 102 located above a physical data center 104. For the sake of illustration, the virtualization layer 102 is separated from the physical data center 104 by a virtual-interface plane 106. The physical data center 104 is an example of a distributed computing system. The physical data center 104 comprises physical objects, including an administration computer system 108, any of various computers, such as PC 110, on which an operations management interface may be displayed in a graphical user interface to system administrators and other users, server computers, such as server computers 112-119, data-storage devices, and network devices. The server computers may be networked together to form server-computer groups within the data center 104. The example physical data center 104 includes three server-computer groups each of which have eight server computers. For example, server-computer group 120 comprises interconnected server computers 112-119 that are connected to a mass-storage array 122. Within each server-computer group, certain server computers are grouped together to form a cluster that provides an aggregate set of resources (i.e., resource pool) to objects in the virtualization layer 102. Different physical data centers may include many different types of computers, networks, data-storage systems, and devices connected according to many different types of connection topologies.

The virtualization layer 102 includes virtual objects, such as virtual machines (“VMs”), applications, and containers, hosted by the server computers in the physical data center 104. A VM is a compute resource that uses software instead of a physical computer to run programs and deploy applications. One or more VMs run on a physical “host” server computer. Each VM runs its own operating system called a “guest operating system” and functions separately from the other VMs, even though the VMs may all be running on the same host. While VMs virtualize the hardware layer to create a virtual computing environment, a container contains a single program or application along with dependencies and libraries and containers share the same operating system. Multiple containers are run in pods on the same server computers. The virtualization layer 102 may also include a virtual network (not illustrated) of virtual switches, routers, load balancers formed from the physical switches, routers, and NICs of the physical data center 104. Certain server computers host VMs while other host containers. For example, server computer 118 hosts two containers identified as Cont₁ and Cont₂; cluster of server computers 112-114 host six VMs identified as VM₁, VM₂, VM₃, VM₄, VM₅, and VM₆; server computer 124 hosts four VMs identified as VM₇, VM₈, VM₉, VM₁₀. Other server computers may host applications. For example, server computer 126 hosts an application identified as App₄. The virtual-interface plane 106 abstracts the resources of the physical data center 104 to one or more VDCs comprising the virtual objects and one or more virtual data stores, such as virtual data stores 128 and 130. For example, one VDC may comprise the VMs running on server computer 124 and virtual data store 128.

Automated methods and systems described below are performed by an operations management server 132 that is executed in one or more VMs on the administration computer system 108. The operations management server 132 is an automated computer implemented tool that aids IT administrators monitor, troubleshoot, and manage the health and capacity of the data center virtual environment. The operations management server 132 provides management across physical, virtual, and cloud environments. The operations management server 132 receives object information, which includes streams of metric data, log messages, and traces from various physical and virtual objects of the data center described below.

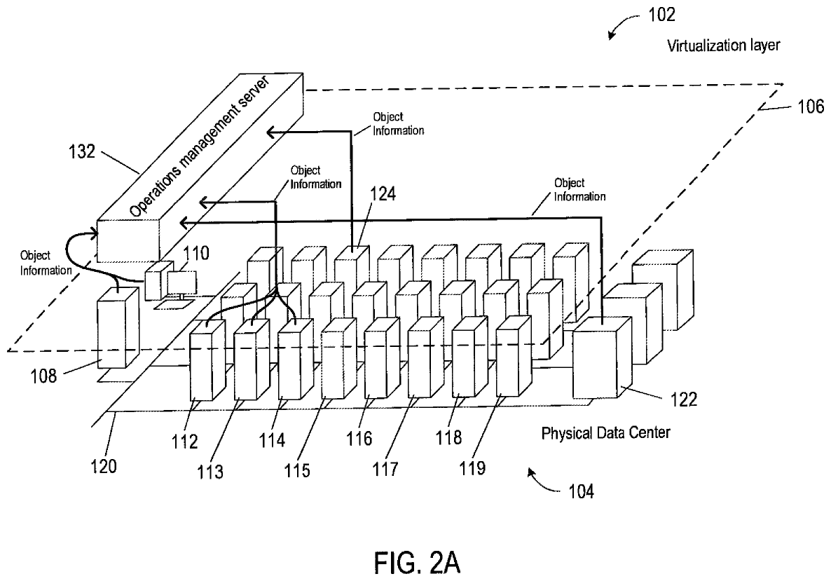

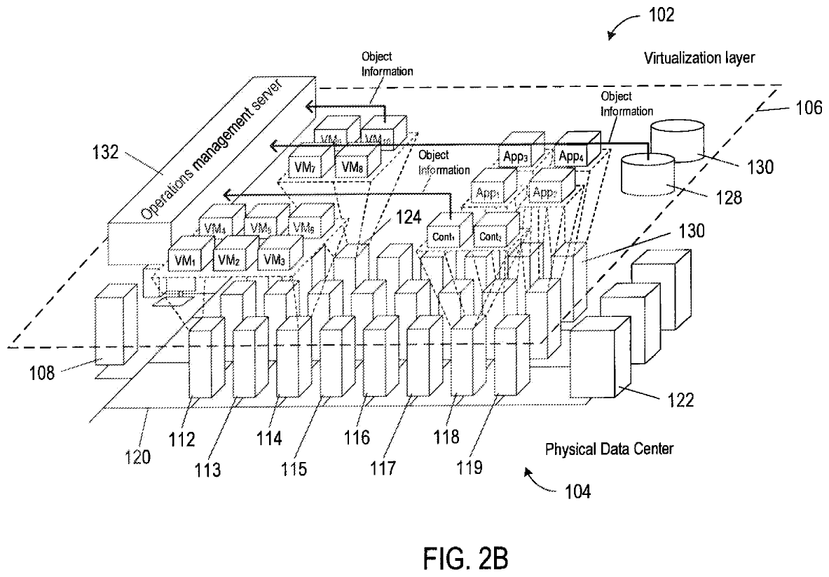

FIGS. 2A-2B show examples of the operations management server 132 receiving object information from various physical and virtual objects. Directional arrows represent object information sent from physical and virtual resources to the management server 132. In FIG. 2A, the operating systems of PC 110, server computers 108 and 124, and mass-storage array 122 send object information to the operations management server 132. A cluster of server computers 112-114 send object information to the operations management server 132. In FIG. 2B, the VMs, containers, applications, and virtual storage may independently send object information to the operations management server 132. Certain objects may send metrics as the object in formation is generated while other objects may only send object information at certain times or when requested to send object information by the operations management server 132. The operations management server 132 may be implemented in a VM to collect and processes the object information as described below to detect performance problems and generate recommendations to correct the performance problems. Depending on the type of the performance problem, recommendations include reconfiguring a virtual network of a VDC or migrating VMs from one server computer to another, powering down server computers, replacing VMs disabled by physical hardware problems and failures, spinning up cloned VMs on additional server computers to ensure that services provided by the VMs are accessible to increasing demand or when one of the VMs becomes compute or data-access bound.

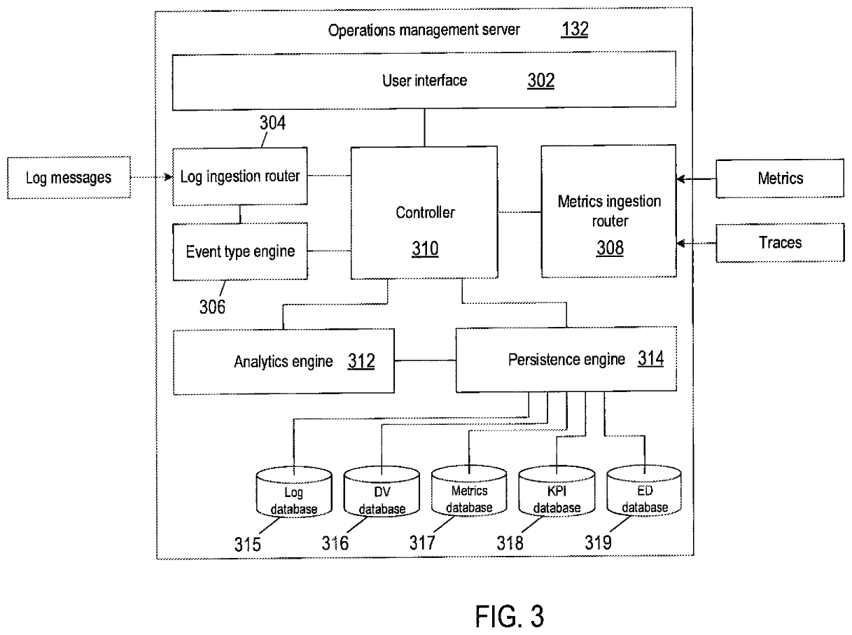

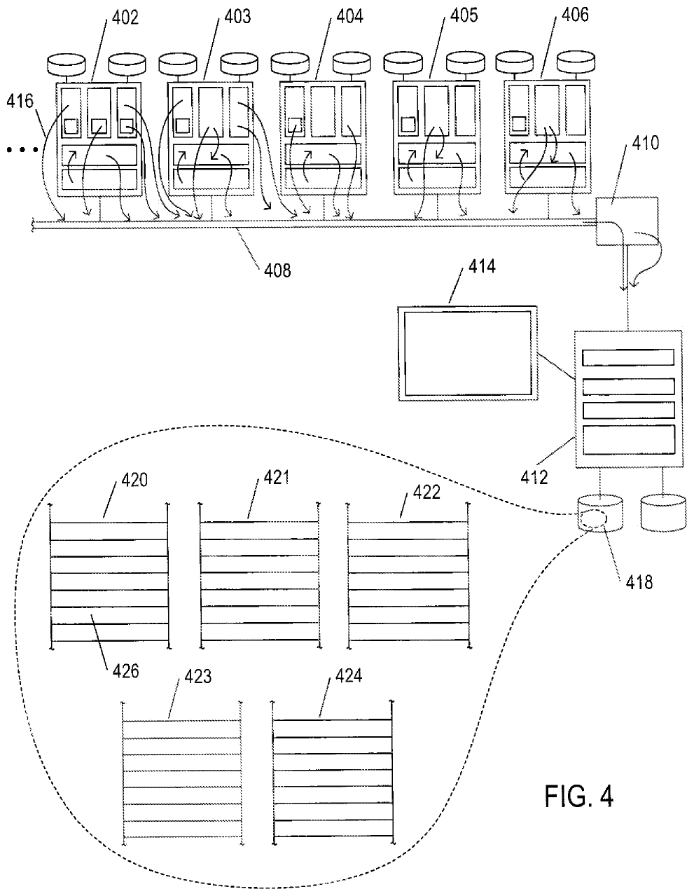

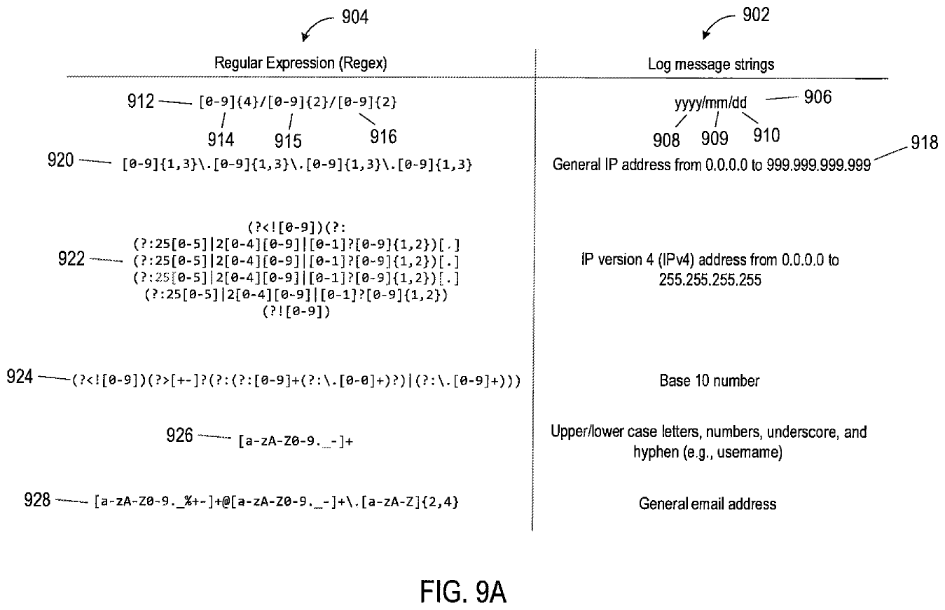

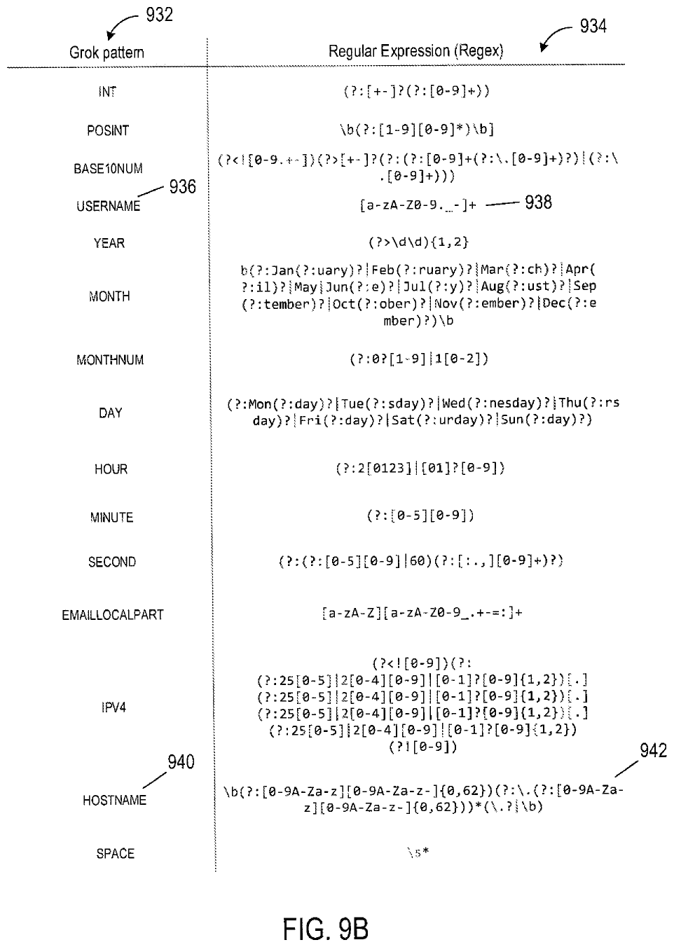

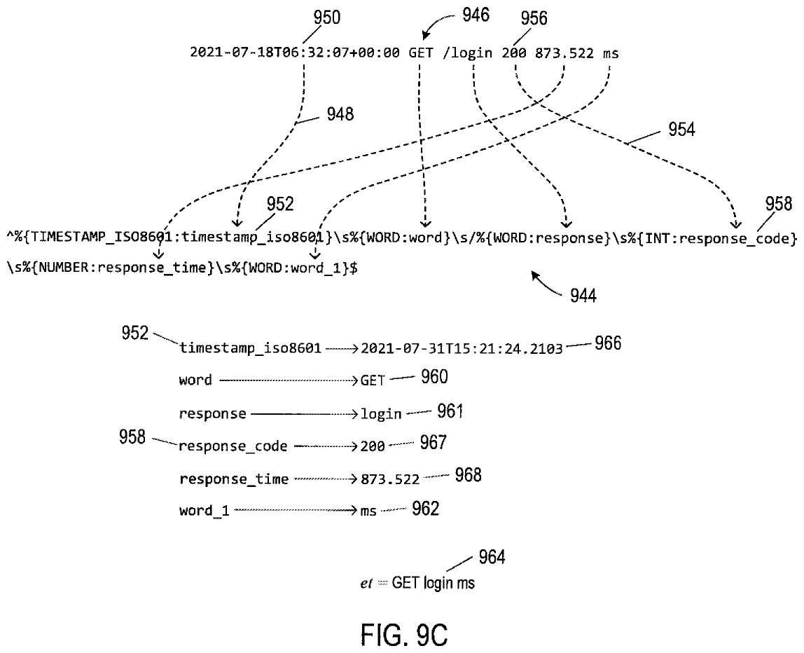

FIG. 3 shows an example architecture of the operations management server 132. This example architecture includes a user interface 302 that provides graphical user interfaces for data center management, system administrators, and application owners to receive alerts, view metrics, log messages, and traces, and execute recommended remedial measures to correct performance problems. The operations management server 132 includes a log ingestion router 304 that receives log messages sent from log monitoring agents deployed at sources of log messages described below with reference to FIGS. 4-8, and an event type engine 306 that extracts event types from the log messages, as described below with reference to FIGS. 9A-9C. The operations management server 132 includes a metrics ingestion router 308 that receives metrics from agents deployed at sources of metric data. The metrics ingestion router 308 receives traces of distributed applications operations from corresponding agents deployed at server computers that execute components of the distributed applications. The operations management server 132 includes a controller 310 that manages and directs the flow of object information collected by the routers 304 and 308. The controller 310 manages the user interface 302 and directs the flow of instructions received via the user interface 302 and the flow of information displayed on the user interface 302. The controller 310 directs the flow of object information to the analytics engine 312. The analytic engine 312 detects various types of events recorded in metrics, event types, and traces and evaluates the events to trigger alerts. The analytics engine 312 performs system health assessments by monitoring key performance indicators (“KPIs”) for problems with applications, maintains dynamic thresholds of metrics, generates alerts in response to KPIs that violate corresponding thresholds. The analytics engine 312 uses machine learning as described below to generate inference models that relate the object information of the applications to corresponding KPIs of the applications. The persistence engine 314 stores information in, and retrieves information from, the data bases 315-318.

### Log Messages

FIG. 4 shows an example of logging log messages in log files. In FIG. 4, computer systems 402-406 within a data center are linked together by an electronic communications medium 408 and additionally linked through a communications bridge/router 410 to an administration computer system 412 that includes an administrative console 414. Each of the computer systems 402-406 may run a log monitoring agent that forwards log messages to the operations management server 132 executing on the administration computer system 412. As indicated by curved arrows, such as curved arrow 416, multiple components within each of the computer systems 402-406 as well as the communications bridge/router 410 generate log messages that are forwarded to the administration computer system 412. Each log message records an event and is generated by any event source. Event sources may be, but are not limited to, programs, operating systems. VMs, guest operating systems, containers, network devices, machine codes, event channels, and other computer programs or processes running on the computer systems 402-406, the bridge/router 410 and any other components of a data center. Log messages may be received by log monitoring agents at various hierarchical levels within a computer system and then forwarded to the administration computer system 412. The operations management server 132 records the log messages in log files 420-424 of the log database 315 of a data-storage device or appliance 418. Rectangles, such as rectangle 426, represent individual log messages. For example, log file 420 may contain a list of log messages generated within the computer system 402. Each log monitoring agent has a configuration that includes a log path and a log parser. The log path specifies a unique file system path in terms of a directory tree hierarchy that identifies the storage location of a log file on the data-storage device 418. The log monitoring agent receives specific file and event channel log paths to monitor log files and the log parser includes log parsing rules to extract and format lines of the log message into log message fields described below.

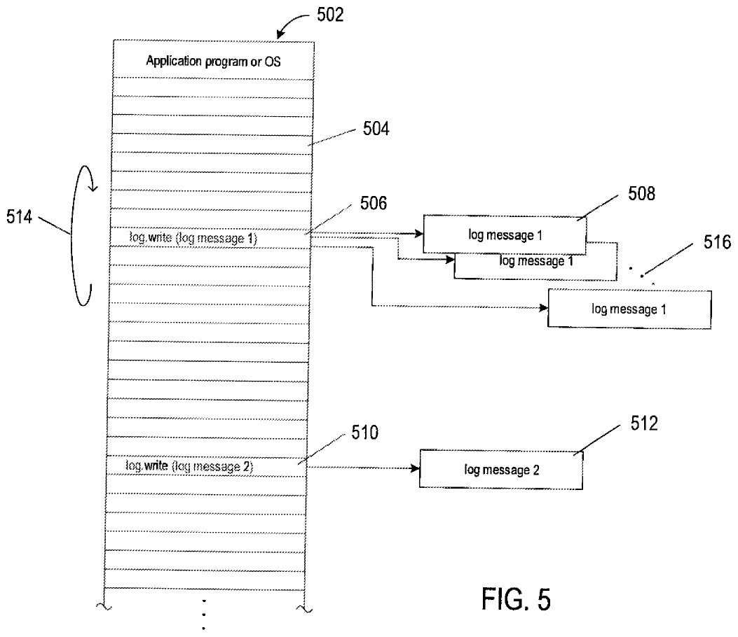

FIG. 5 shows an example source code 502 of an event source. The event source can be an application, an operating system, a VM, a guest operating system, or any other computer program or machine code that generates log messages. The source code 502 is just one example of an event source that generates log messages. Rectangles, such as rectangle 504, represent a definition, a comment, a statement, or a computer instruction that expresses some action to be executed by a computer. The source code 502 includes log write instructions that generate log messages when certain events predetermined by a developer occur during execution of the source code 502. For example, source code 502 includes an example log write instruction 506 that when executed generates a “log message 1” represented by rectangle 508, and a second example log write instruction 510 that when executed generates “log message 2” represented by rectangle 512. In the example of FIG. 5, the log write instruction 508 is embedded within a set of computer instructions that are repeatedly executed in a loop 514. As shown in FIG. 5, the same log message 1 is repeatedly generated 516. The same type of log write instructions may also be located in different places throughout the source code, which in turns creates repeats of essentially the same type of log message in the log file.

In FIG. 5, the notation “log.write( )” is a general representation of a log write instruction. In practice, the form of the log write instruction varies for different programming languages. In general, the log write instructions are determined by the developer and are unstructured, or semi-structured, and in many cases are relatively cryptic. For example, log write instructions may include instructions for time stamping the log message and contain a message comprising natural-language words and/or phrases as well as various types of text strings that represent file names, path names, and perhaps various alphanumeric parameters that may identify objects, such as VMs, containers, or virtual network interfaces. In practice, a log write instruction may also include the name of the source of the log message (e.g., name of the application program, operating system and version, server computer, and network device) and may include the name of the log file to which the log message is recorded. Log write instructions are written in a source code by the developer of a program or operating system in order to record events that occur while an operating system or application program is executing. For example, a developer may include log write instructions that record informative events including, but are not limited to, identifying startups, shutdowns, I/O operations of applications or devices; errors identifying runtime deviations from normal behavior or unexpected conditions of applications or non-responsive devices; fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

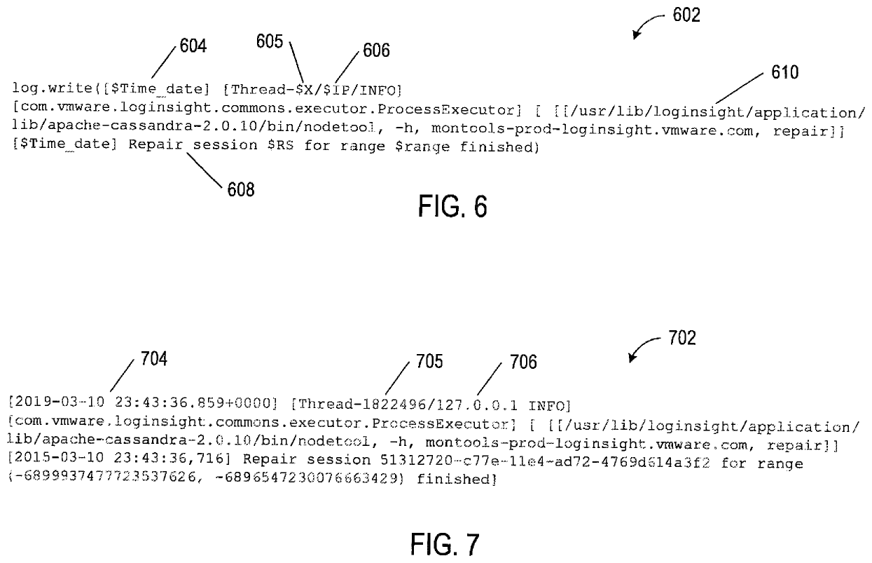

FIG. 6 shows an example of a log write instruction 602. The log write instruction 602 includes arguments identified with “$” that are filled at the time the log message is created. For example, the log write instruction 602 includes a time-stamp argument 604, a thread number argument 606, and an internet protocol (“IP”) address argument 608. The example log write instruction 602 also includes text strings and natural-language words and phrases that identify the level of importance of the log message 610 and type of event that triggered the log write instruction, such as “Repair session” argument 612. The text strings between brackets “[ ]” represent file-system paths, such as path 614. When the log write instruction 602 is executed by a log management agent, parameters are assigned to the arguments and the text strings and natural-language words and phrases are stored as a log message of a log file.

FIG. 7 shows an example of a log message 702 generated by the log write instruction 602. The arguments of the log write instruction 602 may be assigned numerical parameters that are recorded in the log message 702 at the time the log message is executed by the log management agent. For example, the time stamp 604, thread 606, and IP address 608 arguments of the log write instruction 602 are assigned corresponding numerical parameters 704, 706, and 708 in the log message 702. Alphanumeric expression 1910 is assigned to a repair session argument 612. The time stamp 704 represents the date and time the log message 702 was generated. The text strings and natural-language words and phrases of the log write instruction 602 also appear unchanged in the log message 702 and may be used to identify the type of event (e.g., informative, warning, error, or fatal), also called an “event type,” that occurred during execution of the event source.

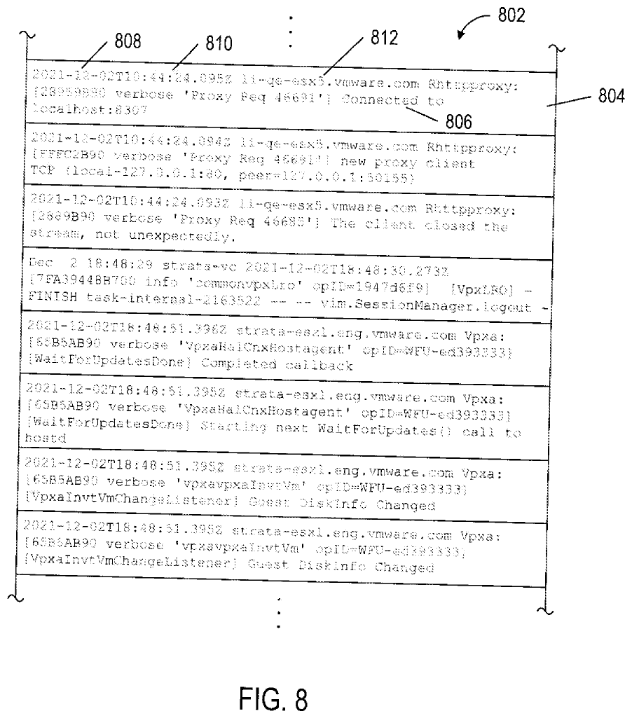

As log messages are received from various event sources, the log messages are stored in corresponding log files of the log database 314 in the order in which the log messages are received. FIG. 8 shows a small, eight-entry portion of a log file 802. In FIG. 8, each rectangular cell, such as rectangular cell 804, of the log file 802 represents a single stored log message. For example, log message 804 includes a short natural-language phrase 806, date 808 and time 810 numerical parameters, and an alphanumeric parameter 812 that identifies a particular host computer.

In one implementation, the event type engine 306 extracts parametric and non-parametric strings of characters called tokens from log messages using regular expressions. A regular expression, also called “regex.” is a sequence of symbols that defines a search pattern in text data. Many regex symbols match letters and numbers. For example, the regex symbol “a” matches the letter “a,” but not the letter “b,” and the regex symbol “100” matches the number “100,” but not the number 101. The regex symbol “.” matches any character. For example, the regex symbol “.art” matches the words “dart,” “cart.” and “tart,” but does not match the words “art,” “hurt,” and “dark.” A regex followed by an asterisk “*” matches zero or more occurrences of the regex. A regex followed by a plus sign “+” matches one or more occurrences of a one-character regex. A regular expression followed by a questions mark “?” matches zero or one occurrence of a one-character regex. For example, the regex “a*b” matches b, ab, and aaab but does not match “baa.” The regex “a-b” matches ab and aaab but does not match b or baa. Other regex symbols include a “\d” that matches a digit in 0123456789, a “\s” matches a white space, and a “\b” matches a word boundary. A string of characters enclosed by square brackets. [ ], matches any one character in that string. A minus sign “−” within square brackets indicates a range of consecutive ASCII characters. For example, the regex [aeiou] matches any vowel, the regex [a-f] matches a letter in the letters abcdef, the regex [0-9] matches a 0123456789, the regex [._%+−] matches any one of the characters._%+−. The regex [0-9a-f] matches a number in 0123456789 and a single letter in abcdef. For example, [0-9a-f] matches a6, i5, and u2 but does not match ex, 9v, or %6. Regular expressions separated a vertical bar “|” represent an alternative to match the regex on either side of the bar. For example, the regular expression Get|GetValue|Set|SetValue matches any one of the words: Get, GetValue, Set, or SetValue. The braces “{ }” following square brackets may be used to match more than one character enclosed by the square brackets. For example, the regex [0-9]{2} matches two-digit numbers, such as 14 and 73 but not 043 and 4, and the regex [0-9]{1-2} matches any number between 0 and 99, such as 3 and 58 but not 349.

Simple regular expressions are combined to form larger regular expressions that match character strings of log messages and can be used to extract the character strings from the log messages. FIG. 9A shown a table of examples of regular expressions designed to match particular character strings of log messages. Column 902 list six different types of strings that may be found in log messages. Column 904 list six regular expressions that match the character strings listed in column 902. For example, an entry 906 of column 902 represents a format for a date used in the time stamp of many types of log messages. The date is represented with a four-digit year 908, a two-digit month 909, and a two-digit day 910 separated by slashes. The regex 912 includes regular expressions 914-916 separated by slashes. The regular expressions 914-916 match the characters used to represent the year 908, month 909, and day 910. Entry 918 of column 902 represents a general format for internet protocol (“IP”) addresses. A typical general IP address comprises four numbers. Each number ranges from 0 to 999 and each pair of numbers is separated by a period, such as 27.0.15.123. Regex 920 in column 904 matches a general IP address. The regex [0-9]{1-3} matches a number between 0 and 999. The backslash “\” before each period indicates the period is part of the IP address and is different from the regex symbol “.” used to represent any character. Regex 922 matches any IPv4 address. Regex 924 matches any base-10 number. Regex 926 matches one or more occurrences of a lower-case letter, an upper-case letter, a number between 0 and 9, a period, an underscore, and a hyphen in a character string. Regex 928 matches email addresses. Regex 928 includes the regex 926 after the ampersand symbol.

In another implementation, the event-type engine 306 extracts non-parametric tokens from log messages using Grok expressions. Grok patterns are predefined symbolic representations of regular expressions that reduce the complexity of constructing regular expressions. Grok patterns are categorized as either primary Grok patterns or composite Grok patterns that are formed from primary Grok patterns. A Grok pattern is called and executed using the notation Grok syntax %{Grok pattern}.

FIG. 98 shows a table of examples of primary Grok patterns and corresponding regular expressions. Column 932 contains a list of primary Grok patterns. Column 934 contains a list of regular expressions represented by the Grok patterns in column 932. For example, the Grok pattern “USERNAME” 936 represents the regex 938 that matches one or more occurrences of a lower-case letter, an upper-case letter, a number between 0 and 9, a period, an underscore, and a hyphen in a character string. Grok pattern “HOSTNAME” 940 represents the regex 942 that matches a hostname. A hostname comprises a sequence of labels that are concatenated with periods. Note that the list of primary Grok patterns shown in FIG. 9 is not an exhaustive list of primary Grok patterns.

Grok patterns may be used to map specific character strings into dedicated variable identifiers. Grok syntax for using a Grok pattern to map a character string to a variable identifier is given by:
%{GROK_PATTERN:variable_name}

where
GROK_PATTERN represents a primary or a composite Grok pattern, and
variable_name is a variable identifier assigned to a character string in text data that matches the GROK_PATTERN.
   A Grok expression is a parsing expression that is constructed from Grok patterns that match characters strings in text data and may be used to parse character strings of a log message. Consider, for example, the following simple example segment of a log message:
34.5.243.1 GET index.html 14763 0.064
   A Grok expression that may be used to parse the example segment is given by:
\hat{ }%{IP:ip_address}\s%{WORD:word}\s%{URIPATHPARAM:request}\s
%{INT:bytes}\s%{NUMBER:duration}$
   The hat symbol “\hat{ }” identifies the beginning of a Grok expression. The dollar sign symbol “$” identifies the end of a Grok expression. The symbol “\s” matches spaces between character strings in the example segment. The Grok expression parses the example segment by assigning the character strings of the log message to the variable identifiers of the Grok expression as follows:
ip_address: 34.5.243.1
word: GET
request: index.html
bytes: 14763
duration: 0.064

Different types of regular expressions or Grok expressions are configured to match token patterns of log messages and extract tokens from the log messages. Numerous log messages may have different parametric tokens but the same set of non-parametric tokens. The non-parametric tokens extracted from a log message describe the type of event, or event type, recorded in the log message. The event type of a log message is denoted by Eᵢ, where subscript i is an index that distinguishes the different event types of log messages. Many event types correspond to benign events recorded in log message while event types that describe errors, warning or critical problems are identified by the operation management server 132.

FIG. 9C shows an example of a Grok expression 944 used to extract tokens from a log message 946. Dashed directional arrows represent parsing the log message 946 such that tokens that correspond to Grok patterns of the Grok expression 944 are assigned to corresponding variable identifiers. For example, dashed directional arrow 948 represents assigning the time stamp 2021-07-18T06:32:07+00:00 950 to the variable identifier timestamp_iso8601 952 and dashed directional arrow 954 represents assigning HTTP response code 200 956 to the variable identifier response code 958. FIG. 9C shows assignments of tokens of the log message 946 to variable identifiers of the Grok expression 944. The combination of non-parametric tokens 960-962 identify the event type 964 of the log message 946. Parametric tokens 966-968 may change for different log messages with the same event type 964.

Unexpected behavior in an object of a data center may be categorized as an anomaly or a change. An anomaly is an extreme event that has essentially the same overall characteristics in the present as in the past. On the other hand, a change is an alteration in the characteristics of the process itself and is regarded an event. A change point is a point in time when the change in behavior of an object begins. The analytics engine 312 automatically detects changes, or change events, in an object behavior based on changes in the distributions of the event types generated by an object.

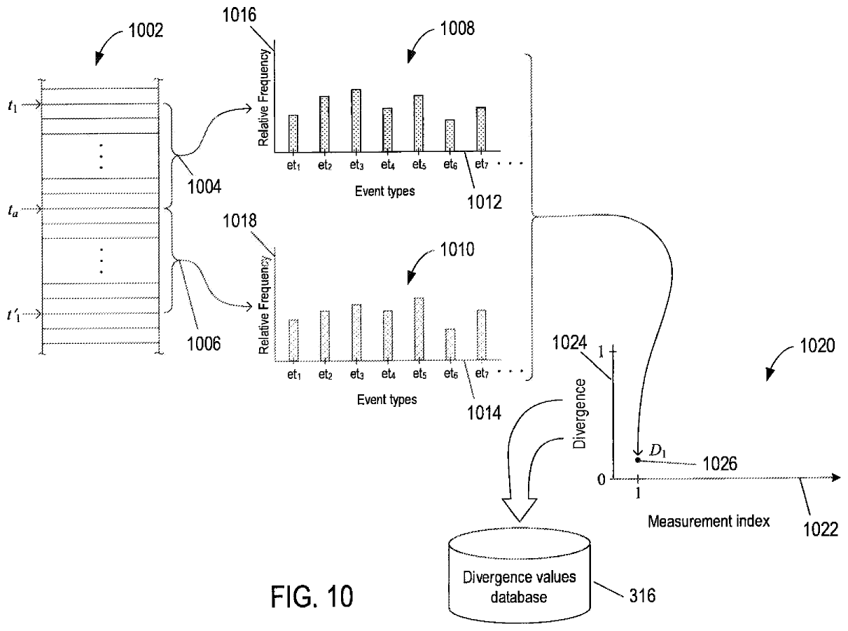

FIG. 10 shows a portion of a log file 1002 of log messages with time stamps that lie in the time interval [t₁,t′₁]. The time interval [t₁, t′₁] is divided into two sub-time intervals [t₁, tₐ] and [tₐ, t′₁], where tₐ marks a point in which approximately half of the log messages are in each of the sub-time intervals. A first set of log messages 1004 has time stamps in the first time interval [t₁, tₐ]. A second set of log messages 1006 has time stamps in the second time interval [tₐ, t′₁]. The operations management server 132 determines the event types for each of the log messages in the separate time intervals and determines the relative frequency of each event type in the separate time intervals. A relative frequency is computed for each event type of the first set of log messages 1004 as follows:

$${F}_{l} = \frac{{n}_{F} ( e {t}_{l} )}{{N}_{F}} \qquad ( 1 a )$$

where
subscript l denotes an event type index:
n_{F}(etᵢ) is the number of times the event type etₗ appears in the first set of log messages 1004; and
N_{F} is the total number log messages in the first set of log messages 1004.
   A relative frequency is computed for each event type of the second set of log messages 1006:

$${G}_{l} = \frac{{n}_{G} ( e {t}_{l} )}{{N}_{G}} \qquad ( 1 b )$$

where
n_{G}(etᵢ) is the number of times the event type etₗ appears in the second set of log messages 1006; and
N_{G} is the total number log messages in the second set of log messages 1006

FIG. 10 shows a plot of a first event-type distribution 1008 of the event types of the log messages 1004 and a plot of a second event-type distribution 1010 of the event types of the log messages 1006. Horizontal axes 1012 and 1014 represent the various event types. Vertical axes 1016 and 1018 represent relative frequency ranges. Shaded bars represent the relative frequency of each event type.

The operations management server 132 computes a divergence value between the first and second event-type distributions. The divergence value is a quantitative measure of a change to the object based on changes in the event types in the first and second time intervals. In one implementation, a divergence value is computed between first and second event-type distributions using the Jensen-Shannon divergence:

$${D}_{i} = - {\sum }_{l = 1}^{{N}_{ET}} {M}_{l} log {M}_{l} + \frac{1}{2} [ {\sum }_{l = 1}^{{N}_{E T}} {F}_{l} log {F}_{l} + {\sum }_{l = 1}^{{N}_{ET}} {G}_{l} log {G}_{l} ] \qquad ( 2 )$$

where
the subscript “i” represents a measurement index;
Mₗ=(Fₗ+Gₗ)/2; and
N_{ET} is the number of event types of the log messages.
   In another implementation, the divergence value may be computed using an inverse cosine as follows:

$${D}_{i} = 1 - \frac{2}{π} {cos}^{- 1} [ \frac{{\sum }_{i = 1}^{{N}_{ET}} {F}_{l} {G}_{l}}{\sqrt{{\sum }_{l = 1}^{{N}_{E T}} {( {F}_{l} )}^{2}} \sqrt{{\sum }_{l = 1}^{{N}_{ET}} {( {G}_{l} )}^{2}}} ] \qquad ( 3 )$$

The divergence value Dᵢ computed according to Equation (2) or (3) satisfies the following condition

0≤Dᵢ≤1 (4)

The divergence value is a normalized value that is used to measure how much, or to what degree, the first event-type distribution differs from the second event-type distribution. The closer the divergence is to zero, the closer the first event-type distribution is to matching the second event-type distribution. For example, when Dᵢ=0, the first event-type distribution is identical to the second event-type distribution, which is an indication that the state of the object has not change from the first sub-time interval [t₁, tₐ] to the second sub-time interval [tₐ, t′₁]. On the other hand, the closer the divergence is to one, the farther the first event-type distribution is from the second event-type distribution. For example, when Dᵢ=1, the first and second event-type distributions have no event types in common.

FIG. 10 shows a plot 1020 of an example divergence value computed for the first event-type distribution 1008 and the second event-type distribution 1010. Horizontal axis 1022 represents measurement indices. Vertical axis 1024 represents the divergence. Dot 1026 represents the example divergence computed for the first event-type distribution 1008 and the second event-type distribution 1010. Note that the divergence value is close to zero, which indicates the distributions 1008 and 1010 are similar. The divergence values are stored in the divergence values database 316.

The time window is then moved or slides to a next time interval [t₂, t′₂] by a time step denoted by δ. The time step is less than the length of the time window Δ (i.e., δ<∇). For example, the time step may be 30 seconds, 1 minute, 2 minutes, 5 minutes, or of any suitable duration that is less than the length of the time window. As a result, the time interval [t₂, t′₂] overlaps the previous time interval [t₁, t′₁].

As the time window incrementally advances or slides in time by the time step δ, a divergence value is computed for log messages generated in the time interval covered by the time window as described above with reference to FIG. 10. The divergence values computed over time to form a sequence of divergence values represented by

DV=(Dᵢ)ᵢ₌₁^{N}^{ₗ} (5)

where
i=1, . . . , Nₗ are measurement indices; and
Nₗ is the number of measurements.

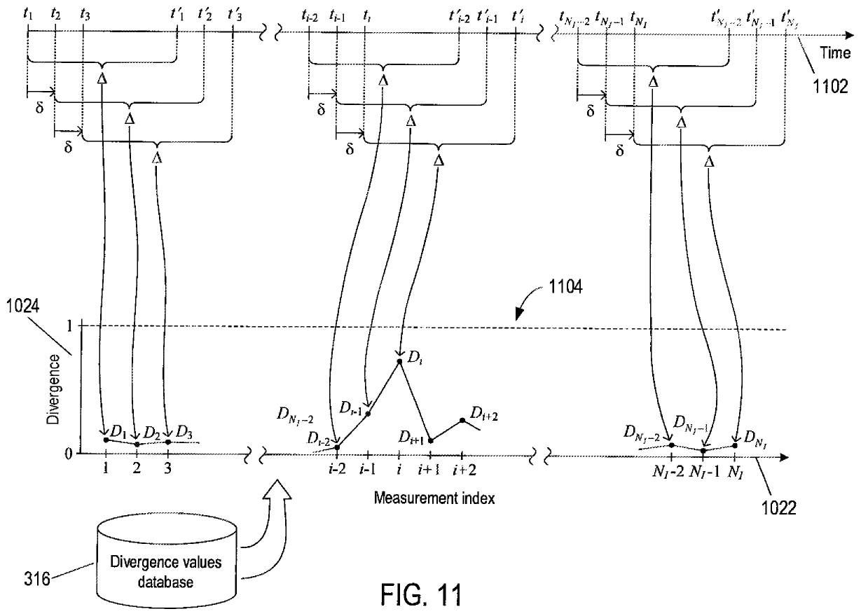

FIG. 11 shows a plot of an example sequence of N consecutive divergence values computed for N overlapping time windows. Overlapping time intervals located on the time axis 1102 correspond to locations of the sliding time window incrementally advanced in time by the time step δ. FIG. 11 includes a plot of divergence values 1104 computed for log messages with time stamps in each time window. Divergence values represented by dots are computed for log messages with time stamps in each of the overlapping time intervals located along the time axis 1102 as described above with reference to FIG. 10. Most of the divergence values are close to zero, which indicates no significant change in the log messages generated by the event source over time. On the other hand, larger divergence value Dₙ 1106 indicates a change has occurred in the object associated with the log messages. However, it is not clear when the change occurred.

When a divergence value is greater than a divergence value threshold

Dᵢ>Th₁ (6)

the divergence value indicates a change in the event source. The divergence value threshold represents a limit for acceptable divergence value changes. For example, the divergence value threshold may be equal to 0.1, 0.15, or 0.2. In other implementations, when a rate of change in divergence values is greater than a rate of change threshold

Dᵢ−Dᵢ₋₁>Th₂ (7)

the divergence value Dᵢ indicates a change in the object. The rate of change threshold represents a limit for acceptable increases between consecutive divergence values. For example, the rate of change threshold may be equal to 0.1, 0.15, or 0.2. When a change has been determined by either of the threshold violations represented in Equations (6) and (7), change point analysis is applied to the sequence of divergences values in order to quantitatively detect a change point for the object. The change point is then used to determine a potentially earlier start time of change in the object.

Change point analysis includes computing cumulative sums of divergence values as follows:

$${S}_{i} = {S}_{i - 1} + ( {D}_{i} - \overline{D} ) \qquad ( 8 )$$

$$where$$

$${S}_{0} = 0 ;$$

$$i = 1 , … , {N}_{l} ;$$

$$and$$

$$\overline{D} = \frac{1}{{N}_{l}} {\sum }_{i = 1}^{{N}_{l}} {D}_{i}$$

is the mean value of the divergence values. In other implementations, rather than using the mean value, D̅ is the median of the sequence of divergence values.

The measurement index of the largest cumulative sum value in the sequence of cumulative sum values is determined:

Sₘ=max((Sᵢ)ᵢ₌₁^{N}^{ₗ}) (9)

where m is the measurement index of the maximum cumulative sum value Sₘ.

The measurement index m is called the chance point. The change point index n is the index of the time interval [tₘ, t′ₘ] in which the change is detected by the maximum cumulative sum. The start time of the change is determined by initially partitioning the divergence values into two sequences of divergence values based on the change point index m as follows:

DV=(Dᵢ)ᵢ₌₁^{N}^{ₗ}=(Dᵢ)ᵢ₌₁^{m}∪(Dᵢ)ᵢ₌ₘ₊₁^{N}^{ₗ} (10)

The first and second sequences of divergence values (Dᵢ)ᵢ₌₁^{m} and (Dᵢ)ᵢ₌ₘ₊₁^{N}^{ₗ} are used to compute the mean square error of the sequence of divergences values as follows:

$$M S E ( m ) = {\sum }_{i = 1}^{m} {( {D}_{i} - {\overline{D}}_{1 , m} )}^{2} + {\sum }_{i = m + 1}^{{N}_{l}} {( {D}_{i} - {\overline{D}}_{1 , m + 1 , {N}_{l}} )}^{2} \qquad ( 11 )$$

$$where$$

$${\overline{D}}_{1 , m} = \frac{1}{m} {\sum }_{i = 1}^{m} {D}_{i}$$

$${\overline{D}}_{m + 1 , N} = \frac{1}{{N}_{l} - m} {\sum }_{i = m + 1}^{{N}_{l}} {D}_{i}$$

The quantity D̅_{1,m} is the average of the first sequence of divergence values. The quantity D̅_{m+1,N}_{ₗ} is the average of the second sequence of divergences values. Starting with a measurement index k equal to the change point index m, and decrementing until k=1, a mean square error MSE(k) is computed according to Equation (11) until a mean square error MSE(k) that is less than or equal to MSE(m) is determined. The largest measurement index k that is less than the change point index in and satisfies the condition MSE(k)≤MSE(m) corresponds to a time interval [tₖ, t′ₖ], where the time tₖ is the approximate start time of change and k is called the start time of change index. If MSE(k)>MSE(m) for k=1, . . . , m, then the start time of change is the change point tₘ. The following pseudocode represents one of many different ways of determining a start time of change:

| | |
|---|---|
| 1 | int k = m; |
| 2 | for (k = m − 1; k = 0; k−−) |
| 3 | { |
| 4 | compute MSE (k): // using Equation (11) |
| 5 | if (MSE (k) ≤ MSE (m)) |
| 6 | { |
| 7 | Start time of change index = k; |
| 8 | return (Change index); |
| 9 | } |
| 10 | } |
| 11 | Start time of change index = m; |
| 12 | return (Change index); |

The above procedure minimizes the mean square error by decrementing from the measurement index m until a measurement index k that satisfies the condition MSE(k)≤MSE(m) is determined. The resulting start time of change index k is a “best” partition of the divergence values for which the divergence values in the sequence (Dᵢ)ᵢ₌₁^{k} and the divergence values in the sequence (Dᵢ)ᵢ₌ₖ₊₁^{m} are maximum fits to the respective means of these two sequences.

### Metrics

Each stream of metric data sent to the operations management server 132 is time series data generated by an operating system of an object, a resource utilized by the object, or by an object itself. A stream of metric data associated with a resource comprises a sequence of time-ordered metric values that are recorded in spaced points in time called “time stamps.” A stream of metric data is simply called a “metric” and is denoted by

m=(xᵢ)ᵢ₌₁^{N}^{ₘ}=(x(tᵢ))ᵢ₌₁^{N}^{ₘ} (12)

where
Nₘ is the number of metric values in the sequence;
xᵢ=x(tᵢ) is a metric value;
tᵢ is a time stamp indicating when the metric value was recorded in a data-storage device; and
subscript i is a time stamp index i=1, . . . , Nₘ.

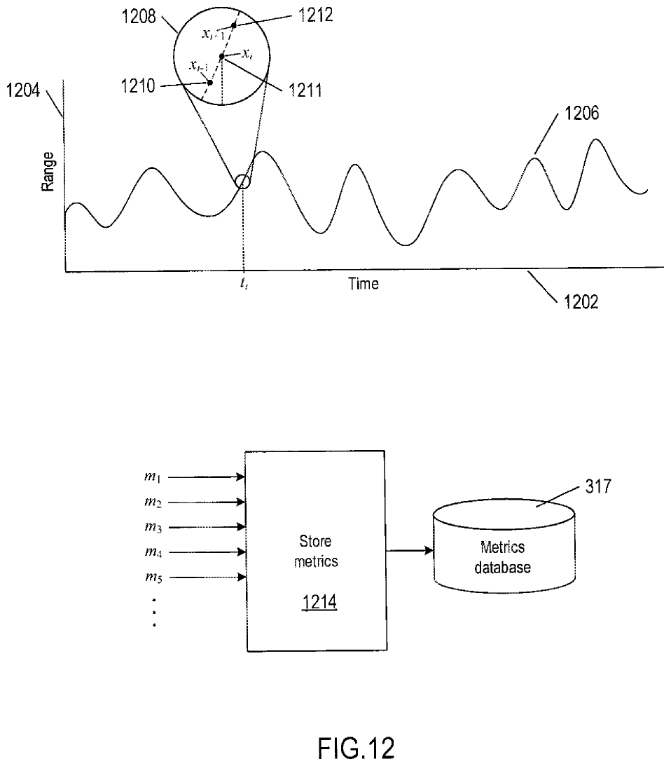

FIG. 12 shows a plot of an example metric. Horizontal axis 1202 represents time. Vertical axis 1204 represents a range of metric value amplitudes. Curve 1206 represents a metric as time series data. In practice, a metric comprises a sequence of discrete metric values in which each metric value is recorded in a data-storage device. FIG. 12 includes a magnified view 1208 of three consecutive metric values represented by points. Each point represents an amplitude of the metric at a corresponding time stamp. For example, points 1210-1212 represent consecutive metric values (i.e., amplitudes) xᵢ₋₁, xᵢ, and xᵢ₊₁ recorded in a data-storage device at corresponding time stamps tᵢ₋₁, tᵢ, and tᵢ₊₁. FIG. 12 shows an example of storing metrics denoted by mᵢ, where i=1, 2, 3, . . . . Block 1214 represents a store metrics operation performed by the operations management server 132 to store each of the metrics in a metrics database 316. Each metric value xᵢ represents a measurement of an object or amount of a resource used by an object at a point in time and is stored in the metrics database as a three tuple (xᵢ, tᵢ, object), where “object” identifies the object, such as a particular VM, server computer, or network device.

Metrics represent different types of measurable quantities of physical and virtual objects of a data center and are stored in a metric database of a data storage appliance. A metric can represent CPU usage of a core in a multicore processor of a server computer over time. A metric can represent the amount of virtual memory a VM uses over time. A metric can represent network throughput for a server computer. Network throughput is the number of bits of data transmitted to and from a physical or virtual object and is recorded in megabits, kilobits, or bits per second. A metric can represent network traffic for a server computer or a VM. Network traffic at a physical or virtual object is a count of the number of data packets received and sent per unit of time. A metric may can represent object performance, such as CPU contention, response time to requests, and wait time for access to a resource of an object. Network flows are metrics that indicate a level of network traffic. Network flows include, but are not limited to, percentage of packets dropped, data transmission rate, data receiver rate, and total throughput.

Each metric has at least one corresponding threshold, denoted by Th_{metric}, that is used by the analytics engine 312 to detect events associated with an object of the data center. An event may be an indication that the object is in an abnormal state. Depending on the type of metric, the corresponding threshold Th_{metric} can be a dynamic threshold that is automatically adjusted by the analytics engine 312 to changes in the object or data center over time or the threshold can be a fix threshold. For example, when one or more metric values of a metric violate a threshold, such as xᵢ>Th_{metric} for an upper threshold or xᵢ<Th_{metric} for a lower threshold, an event has occurred with a corresponding object indicating that the object has entered an abnormal state. Determination of thresholds and detection of events in metrics is described in U.S. Pat. No. 10,241,887, which is owned by VMware Inc. and is hereby incorporated by reference. The type of event, or event type, is determined by the type of metric. For example, when CPU usage violates a corresponding threshold, the violation is a type of event, and event type.

### Traces

A trace represents a workflow executed by an application, such as a component of a distributed application. A trace represents how a request, such as a user request, propagates through components of a distributed application or through services provided by each component of a distributed application. A trace consists of one or more spans, which are the separate segments of work represented in the trace. Each span represents an amount of time spent executing a service of the trace.

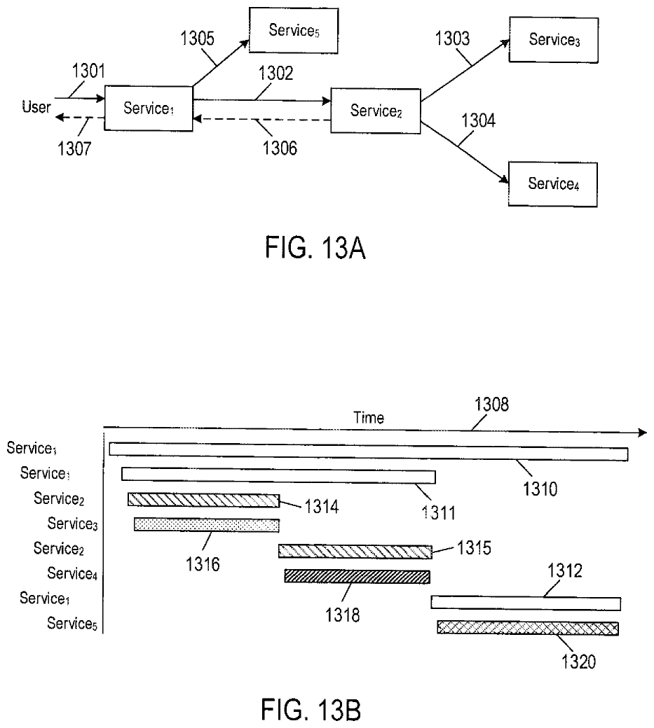

FIGS. 13A-13B show an example of a distributed application and an example application trace. FIG. 13A shows an example of five services provided by a distributed application. The services are represented by blocks identified as Service₁, Service₂, Service₃, Service₄, and Service₅. The services may be web services provided to customers. For example, Service₁ may be a web server that enables a user to purchase items sold by the application owner. The services Service₂, Service₃. Service₄, and Service₅ are computational services that execute operations to complete the user's request. The services may be executed in a distributed application in which each component of the distributed application executes a service in a separate VM on different server computers or using shared resources of a resource pool provided by a cluster of server computers. Directional arrows 1301-1305 represent requests for a service provided by the services Service₁, Service₂, Service₃, Service₄, and Service₅. For example, directional arrow 1301 represents a user's request for a service, such as provided by a web site, offered by Service₁. After a request has been issued by the user, directional arrows 1303 and 1304 represent the Service₁ request for execution of services from Service₂ and Service₃. Dashed directional arrows 1306 and 1307 represent responses. For example, Service₂ sends a response to Service₁ indicating that the services provided by Service₃ and Service₄ have been executed. The Service: then requests services provided Service₅, as represented by directional arrow 1305, and provides a response to the user, as represented by directional arrow 1307.

FIG. 13B shows an example trace of the services represented in FIG. 13A. Directional arrow 1308 represents a time axis. Each bar represents a span, which is an amount of time (i.e., duration) spent executing a service. Unshaded bars 1310-1312 represent spans of time spent executing the Service₁. For example, bar 1310 represents the span of time Service₁ spends interacting with the user. Bar 1311 represents the span of time Service₁ spends interacting with the services provided by Service₂. Hash marked bars 1314-1315 represent spans of time spent executing Service₂ with services Service₃ and Service₄. Shaded bar 1316 represents a span of time spent executing Service₃. Dark hash marked bar 1318 represents a span of time spent executing Service₄. Cross-hatched bar 1320 represents a span of time spent executing Service₅.

The analytics engine 312 creates and monitors RED metrics from the spans of traces to detect events in the performance of an application. The abbreviation “RED” stands for rate of request metrics, error metrics, and duration metrics. A rate of request metric is the number of requests served per unit time. An error metric is the number of failed requests per unit time. A duration metric is a per unit time histogram distributions of the amount of time that each request takes. RED metrics are KPIs of the overall health of an application and the health of the individual services performed by application components. RED metrics are used by the analytics engine 312 to detect events that are indicators of performance problems with an application and/or individual application components. An event occurs when any one of the RED metrics violates a corresponding threshold as described above with reference to Equation (12). RED metrics include span RED metrics and trace RED metrics.

Span RED metrics measure performance of individual services provided by application components. For example, a span rate of request metric is the number of times that the specified operation performed by a service is invoked per unit time or the number of spans for a specified service per unit time. A span error metric is the number of operations performed by a service per unit time that have errors. A span duration metric of each invoked service in microseconds may be aggregated in one-minute intervals. Duration of each span, in microseconds, are aggregated in one-minute time intervals.

Trace RED metrics measure traces that start with a given root service. If a trace has multiple root spans, the earliest occurring root span is used. Trace RED metrics are determined from each trace's root span and end span. A trace rate of request metric is the number of traces that start with the specified root service per unit time. A trace error metric is the number of traces that start with the same root service and contain one or more spans with errors. A trace duration metric is measured from the start of the earliest root span to the end of the last span in a trace.

### Key Performance Indicators

The analytics engine 312 constructs certain key performance indicators (“KPIs”) of application performance and stores the KPIs in the KPI database 318. An application can have numerous associated KPIs. Each KPI of an application measures a different feature of application performance and is used by the analytics engine 312 to detect particular performance problems. A KPI is a metric constructed from other metrics and is used as a indicator of the health of an application executing in the data center. A KPI is denoted by

(yᵢ)ᵢ₌₁^{L}(y(tᵢ))ᵢ₌₁^{L} (13)

where
yᵢ=y(tᵢ) is a metric value; and
L is the number of KPI values recorded over time.

A distributed resource scheduling (“DRS”) score is an example of a KPI that is constructed from other metrics and is used to measure the performance level of a VM, container, or components of a distributed application. The DRS score is a measure of efficient use of resources (e.g., CPU, memory, and network) by an object and is computed as a product of efficiencies as follows:

$$y ( {t}_{i} ) = {EFFCY}_{CPU} ( {t}_{i} ) \times {EFFCY}_{Mem} ( {t}_{i} ) \times {EFFCY}_{Net} ( {t}_{i} ) \qquad ( 14 )$$

$$where$$

$${EFFCY}_{CPU} ( {t}_{i} ) = \frac{CPU usage ( {t}_{i} )}{Ideal CPU usage} ;$$

$${EFFCY}_{Mem} ( {t}_{i} ) = \frac{Memory usage ( {t}_{i} )}{Ideal Memory usage} ;$$

$$and$$

$${EFFCY}_{Net} ( {t}_{i} ) = \frac{Network throughput ( {t}_{i} )}{Ideal Network throughput}$$

The metrics CPU usage(tᵢ), Memory usage(tᵢ), and Network throughput(tᵢ) of an object are measured at points in time as described above with reference to Equation (13). Ideal CPU usage, Ideal Memory usage, and Ideal Network throughput are preset. For example. Ideal CPU usage may be preset to 30% of the CPU and Ideal Memory usage may be preset to 40% of the memory. DRS scores can be used for, example, as a KPI that measures the overall health of a distributed application by aggregating, or averaging, the DRS scores of each VM that executes a component of the distributed application. Other examples of KPIs for an application include average response times to client request, error rates, contention time for resources, or a peak response time. Other types of KPIs can be used to measure the performance level of a cloud application. A cloud application is a distributed application with data storage and logical components of the application executed in a data center and local components provide access to the application over the internet via a web browser or a mobile application on a mobile device. For example, a KPI for an online shopping application could be the number of shopping carts successfully closed per unit time. A KPI for a website may be response times to customer requests. KPIs may also include latency in data transfer, throughput, number of packets dropped per unit time, or number of packets transmitted per unit time.

Each KPI has at least one corresponding KPI threshold, denoted by Th_{KPI}, that is used by the analytics engine 312 to detect in when an application has a performance problem. The corresponding KPI threshold Th_{KPI} can be a dynamic threshold that is automatically adjusted by the analytics engine 312 to changes in the application behavior over time or the threshold can be a fix threshold. When one or more metric values of a metric violate a threshold, such as yᵢ>Th_{KPI} for an upper threshold, or yᵢ<Th_{KPI} for a lower threshold, the application is exhibiting a performance problem.

### Automated Processes for Assessing Behavior of Applications Executing in a Distributed Computing Environment

The operations management server 132 executes an automated process of detecting most likely root causes of performance problems with applications executing in a data center. The automated processes eliminate human errors in detecting application performance problems and significantly reduces the time for detecting the performance problem. For example, the time for detecting the performance problem may be reduced from days and weeks to just minutes and seconds. The process carried out by the operations management server 132 provides notification of a performance problem indicated by a KPI and provides notification of the most likely root causes of the performance. The operations management server 132 also provides one or more recommendations for correcting the performance problem based on the probable root causes of the performance problem.

The controller 132 stores and maintains records of event types for metrics, log messages, divergence values, and KPIs in the databases 315-319. The analytics engine 312 uses machine learning, as described below, to train an inference model for each KPI based on historical events recorded in object information (i.e., metrics, log messages, divergence values, and RED metrics) for an application executing in a data center. The inference model relates the object information to the KPI. The inference model can be a parametric inference model or a non-parametric inference model, depending on how the object information relates to the KPI.

The analytics engine 312 uses machine learning to automatically train an inference model from event types recorded in object information recorded in historical time windows that precede each KPI value. For each historical time window, the analytics engine 312 retrieves metrics, divergence values, and RED metrics that occurred in the time window from the databases 315, 316, and 317 and computes a probability distribution of event types. A probability distribution of various event types that occurred in a historical time window is called an “event-type distribution.”

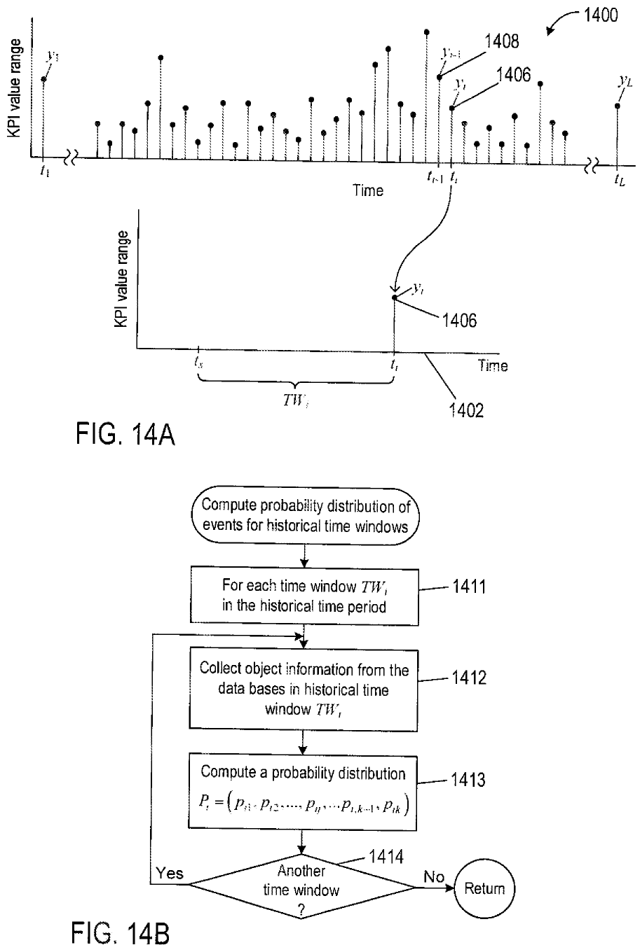

FIG. 14A shows a plot 1400 of historical KPI values of a KPI. Horizontal time axis 1402 represents a historical time period. Vertical axis 1404 represents a range of KPI values. KPI values are represented by solid dots. Each KPI value has a corresponding time stamp. For example, solid dot 1406 represents a KPI value yᵢ at time stamp tᵢ, and solid dot 1408 represents a KPI value yᵢ₋₁ at time stamp tᵢ₋₁. FIG. 14A shows an example of a historical time window denoted by TWᵢ that ends at the time stamp tᵢ of the KPI value yᵢ. Time tₛ denotes the start time of the time window TWᵢ. Note that the index i relates the historical time window TWᵢ to the KPI value yᵢ. The start time tₛ can precede the time stamp of the previous time stamp tᵢ₋₁, or the start time tₛ can be after the previous time stamp tᵢ₋₁. The duration of the time window TWᵢ is selected by a user. For example, the duration of the time window may be about 5 minutes, 30 minutes, 1 hour, 6 hours, 12 hours, one day, or one week. The duration of the time window TWᵢ may be a function of the duration between consecutive time stamps tᵢ₋₁ and tᵢ of the KPI. For example, the duration of the TWᵢ is given by α(tᵢ−tᵢ₋₁), where α is a constant greater than zero. A similar historical time window TWᵢ₋₁ is associated with the KPI value yᵢ₋₁. Another historical time window TWᵢ₊₁ is associated with the KPI value yᵢ₊₁.

FIG. 14B is a flow diagram of computing an event-type distribution of events recorded in each historical time window of the historical period. A loop beginning with block 1411 repeats the computational operations represented by blocks 1412 and 1413 for each historical time window. In block 1412, the analytics engine 312 retrieves object information with time stamps in the historical time window from the databases 315-317.

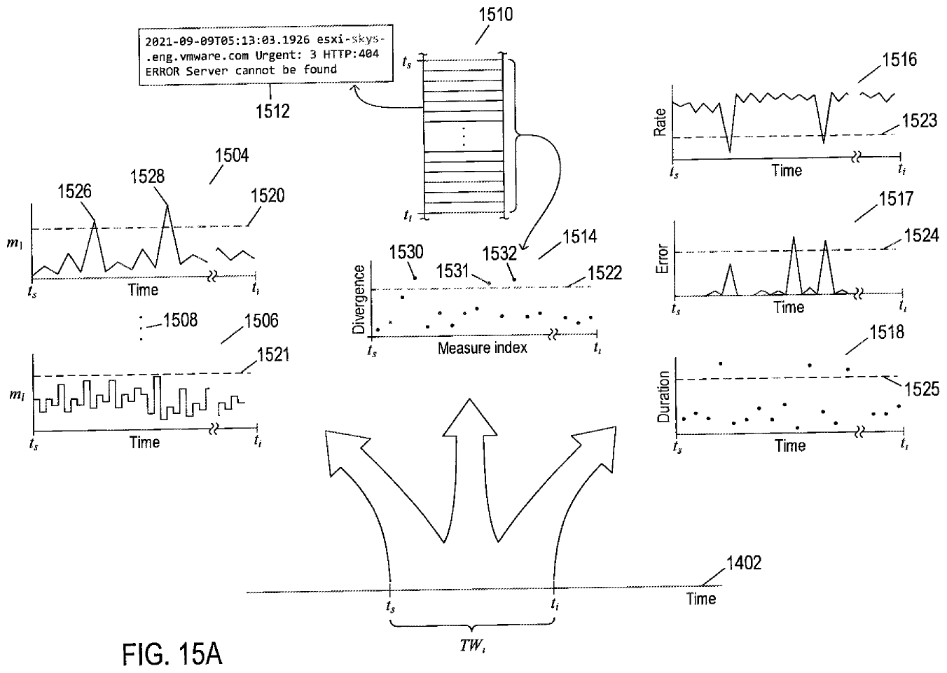

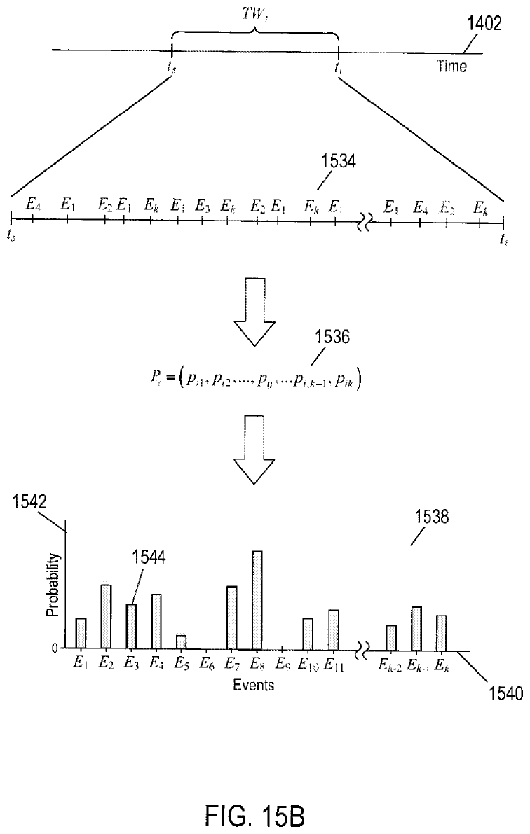

FIG. 15A shows an example of object information retrieved from the databases 315-317 in the time window TWᵢ. FIG. 15A includes the time axis 1402 with the time window TWᵢ. FIG. 15A shows example plots of object information retrieved from the databases 315-318 in the time window TWᵢ. Plots 1504 and 1506 represent examples of metrics m₁ and mᵢ, respectively, associated with the application. Ellipses 1508 represent other metrics associated with the application but are not shown for the sake of convenience. Boxes 1510 represent log messages, such as log message 1512, generated by event sources that are associated with the application in the time window TWᵢ. Event types of the log messages 1510 are determined as described above with reference to FIGS. 9A-9C and are used to compute divergence values and change points in the time window TWᵢ as described above with reference to FIGS. 10 and 11. Plot 1514 represents the divergence values determined in the time window TWᵢ. In this example, the application has associated RED metrics represented by plots 1516-1518. The example plots include thresholds 1520-1525. Metric values that violate a corresponding threshold are the same type of event denoted by Eⱼ, where subscript j is an index that distinguishes the metric or divergence. j=1, 2, . . . k, and k is the number of different possible types of events that are associated with the application. An event type can also be event type of log messages. For example, metric values 1526 and 1528 violate the threshold 1520 and correspond to the same event type denoted by E₁; metric values 1530-1532 violate the threshold 1522 and correspond to the same event type denoted by E_{d}. Note that certain event types may not occur in the time window TWᵢ. For example, metric values that violate the threshold 1521 correspond to another event type denoted by Eᵢ. However, none of the metric values associated with the metric mₗ violated the threshold 1521 in the time window TWᵢ. As a result, the number of event types Eₗ is zero in the time window TWᵢ. The analytics engine 312 maintains a count of the number of times each event type occurred in the time window TWᵢ.

Returning to FIG. 14B, in block 1413, the analytics engine 312 computes an event-type distribution of the events that occurred in each historical time window of the historical period of time. For the time window TWᵢ, the analytics engine 312 computes the probability of an event type Eⱼ as follows:

$${p}_{ij} = \frac{n ( {E}_{j} )}{{N}_{E}} \qquad ( 15 )$$

where
subscript i is the index of the time window TWᵢ (or the KPI value yᵢ);
subscript j is the index of the event type, Eⱼ, that occurred within the time window TWᵢ;
n(Eⱼ) is a count of the number of times the j-th event type Eⱼ occurred in the time window TWᵢ; and
N_{E} is the total number events that occurred in the time window TWᵢ across the different types of events that occurred in the time window TWᵢ(i.e., N_{E}=Σⱼ₌₁^{k}n(Eⱼ)).

The analytics engine 312 assembles the probabilities of the different event types that occurred in the time window TWᵢ into an event-type distribution given by

Pᵢ=(pᵢ₁,pᵢ₂, . . . ,pᵢⱼ, . . . ,p_{i,k-1},pᵢₖ). (16)

In block 1414, the operations represented by blocks 1412 and 1413 are repeated for each of the historical time windows in the historical time period. The analytics engine 312 persists event-type distributions associated with each KPI value in the event-type distribution database 319.

FIG. 15B shows an example of forming an event-type distribution from event types that occurred in the time window TWᵢ. FIG. 15B shows a magnified view 1534 of the time window TWᵢ. Marks located on time axis 1402 represent points in the time window TWᵢ when events associated with the application described above with reference to FIG. 15A where recorded. For example, marks identified as event type E₁ correspond to the threshold violation events of the metric m; in the plot 1504 of FIG. 15A. FIG. 15B shows an example plot 1538 of the event-type distribution 1536. Horizontal axis 1540 identifies the types of events. Vertical axis 1542 is a probability range. Bars represent the values of the probabilities of the event types. For example, bar 1544 represents the value of the probability pᵢ₃ of the event type E₃ occurring in the time window TWᵢ. Note that the event-type distribution 1536 also includes zero probabilities pᵢ₆ and pᵢ₉ for the corresponding event types E₆ and E₉, which means the event types E₆ and E₉ did not occur in the time window TWᵢ.

Note that event-type distributions, in general, may have zero probabilities that correspond to types of events that did not occur in the time window TWᵢ. For example, in FIG. 15A, none of the metric values associated with the metric mᵢ represented by plot 1506 violated the threshold 1521. As a result, n(Eₗ)=0 and the associated probability is pₗₗ=0.

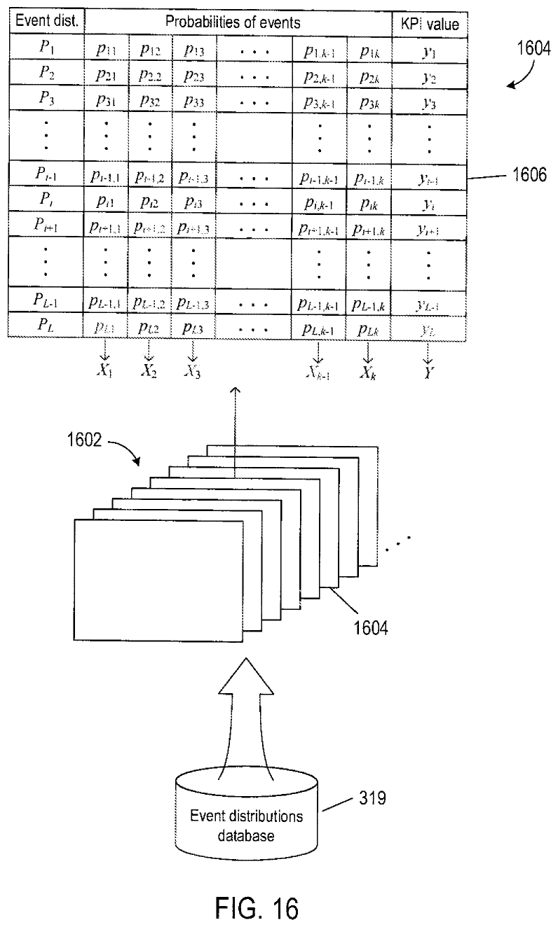

FIG. 16 shows examples of event-type distributions 1602 persisted in the event-type distributions database 319. The event-type distributions for each KPI are stored in separate data tables. FIG. 16 also shows an enlargement of a data table 1604 that records L event-type distributions for each of the L KPI values of a KPI. For example, row 1606 records the KPI value yᵢ and the probabilities of the k event types (i.e., event-type distributions) in Equation (16). Each column contains the probabilities of a particular event type Eⱼ and is denoted by Xⱼ, where j=1, . . . , k. The parameter Xⱼ is called the “event-type probabilities” of the event type Eⱼ. For example, X₁ contains the event-type probabilities of the event type E₁ and X₂ contains the event-type probabilities of the event type E₂. Column 1608 contains the KPI values of the KPI and is denoted by Y.

The analytics engine 312 uses the event-type probabilities, {Xⱼ}ⱼ₌₁^{k}, and the KPI, Y, of an application to train an inference model for the KPI. The inference model can be parametric inference model or non-parametric inference model, depending on the relationship between the event-type probabilities and the KPI. The inference model of the KPI is used as described below to determine event types that are potential root causes of a performance problem with the application as revealed by run-time KPI values of the KPI. The term run time refers to while the application is being executed on a computer system processor.

Parametric Inference Model

For a parametric inference model the set of event-type probabilities {Xⱼ}ⱼ₌₁^{k} are inputs, called “predictors,” and the KPI Y is an output, called the “response.” The relationship between the set of event-type probabilities {Xⱼ}ⱼ₌₁^{k} and the KPI Y is represented by

Y=f({Xⱼ}ⱼ₌₁^{k})+ε (17)
where ε represents a random error.

The random error ε is independent of the event-type probabilities Xⱼ, has a mean zero, and is normally distributed. Here f denotes an unknown model of the relationship between the metrics and the KPI and represents systematic information about Y.

In one implementation, it is assumed that there is a linear relationship between the set of event-type probabilities {Xⱼ}ⱼ₌₁^{k} and the KPI Y. In other words, the unknown function in Equation (17) is a linear parametric function of the set of event-type probabilities:

$$f ( {\{ {X}_{j} \}}_{j = 1}^{k} ) = \overline{X} B = {β}_{0} + {\sum }_{j = 1}^{k} {β}_{j} {X}_{j} \qquad ( 18 )$$

where β₀, β₁, . . . , βₙ are the model coefficients.

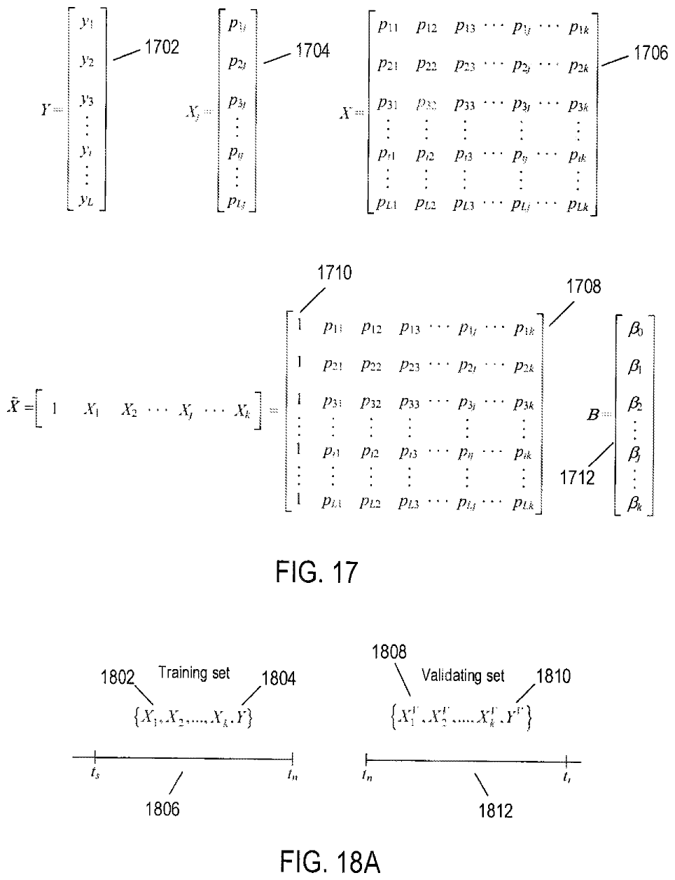

FIG. 17 shows matrix representations of the elements of Equation (18) for the parametric model. Column matrix 1702 contains the KPI values of the KPI Y as described above with reference to FIG. 16. Column matrix 1704 contains event-type probabilities Xⱼ for the event type Eⱼ as described above with reference to FIG. 16. Matrix X 1706 is a matrix formed from the k event-type probabilities. The columns of matrix X 1706 are the event-type probabilities. The rows of matrix X are the event-type distributions Pᵢ, for i=1, . . . , L. A design matrix X 1708 in Equation (18) is formed by adding a column 1710 of ones to the matrix X 1706. Column matrix B 1712 is the model coefficient matrix formed from the model coefficients β₀, β₁, . . . βₙ.

The analytics engine 312 uses the set of event-type probabilities {Xⱼ}ⱼ₌₁^{k} and the KPI Y to train a parametric model \hat{f} that estimates f for any (X,Y)

$$\hat{Y} = \hat{f} ( X ) = \tilde{X} \hat{B} = {\hat{β}}_{0} + {\sum }_{j = 1}^{p} {\hat{β}}_{j} {X}_{j} \qquad ( 19 )$$

where the hat symbol, \hat{ }, denotes an estimated value.

Column matrix \hat{B} contains estimated model coefficients \hat{β}₀, \hat{β}₁ . . . , \hat{β}ₚ, which are estimates of corresponding model coefficients β₀, β₁, . . . , βₚ, and Ŷ is an estimate of the KPI Y. The analytics engine 312 computes the estimated model coefficients using least squares as follows:

\hat{B}=(\tilde{X}^{T}\tilde{X})⁻¹\tilde{X}^{T}Y (20)
where superscript −1 denotes matrix inverse.

Substituting Equation (20) into Equation (19) gives the following transformation between the KPI Y and the estimated KPI Ŷ:

Ŷ=\tilde{X}\hat{B}=\tilde{X}(\tilde{X}^{T}\tilde{X})⁻¹\tilde{X}^{T}Y=HY (21)

In one implementation, the analytics engine 312 determines whether there is a linear relationship between the parametric model obtained in Equation (21) and the KPI and whether at least one of the event-type probabilities is useful in predicting the KPI based on hypothesis testing. The null hypothesis is

H₀: β₁=β₂= . . . =βₚ=0

versus the alternative hypothesis

Hᵤ: at least one βⱼ≠0

A test for the null hypothesis is performed using the F-statistic given by:

$${F}_{0} = \frac{M {S}_{R}}{M {S}_{E}} \qquad ( 22 a )$$

$$where$$

$$M {S}_{R} = \frac{S {S}_{R}}{k}$$

is the regression mean square, and

$$M {S}_{E} = \frac{{SS}_{E}}{L - k - 1}$$

is the error mean square. The numerator of the regression mean square is given by

$$S {S}_{R} = {Y}^{T} ( H - ( \frac{1}{L} ) J ) Y$$

where H is the matrix given in Equation (22) and the matrix J is an L×L square matrix of ones. The numerator of the error mean square is given by

SS_{E}=Y^{T}(I_{L×L}−H)Y

where I_{L×L} is the L×L identity matrix. The analytics engine 312 rejects the null hypothesis when the F-statistic is larger than a threshold, Th_{F}, represented by the condition:

F₀>Th_{F} (22b)

In other words, when the condition in Equation (22b) is satisfied, at least one of the event-type probabilities is related to the KPI. The threshold Th_{F} may be preselected by a user. Alternatively, the threshold may be set to the f-distribution:

Th_{F}=f_{α,k,L-k-1} (22c)

The subscript α is a non-zero probability that may be set to a value less than or equal to 0.10 (i.e., 0<α<1 and α is the area of the tail of the f-distribution computed with degrees of freedom L and L−k−1).

If it is determined that the null hypothesis for the estimated model coefficients is rejected, it may still be the case that one or more of the event-type probabilities are irrelevant and not associated with the KPI Y. Including irrelevant metrics in the computation of the estimate KPI Ŷ leads to unnecessary complexity in the final parametric model. The analytics engine 312 removes irrelevant event-type probabilities (i.e., setting corresponding estimated model coefficients to zero in the model) to obtain a model based on event-type probabilities that more accurately relate to the KPI Y.

In one implementation, when the analytics engine 312 has determined that at least one of the event-type probabilities is relevant, the analytic engine 312 separately assesses the significance of the estimated model coefficients in the parametric model based on hypothesis testing. The null hypothesis for each estimated model coefficient is

H₀: βⱼ=0

versus the alternative hypothesis

Hₐ: βⱼ≠0

The t-test is the test statistic based on the t-distribution. For each estimated model coefficient, the t-test is computed as follows:

$${T}_{j} = \frac{{\hat{β}}_{j}}{S E ( {\hat{β}}_{j} )} \qquad ( 23 a )$$

where SE(\hat{β}ⱼ) is the estimated standard error of the estimated coefficient \hat{β}ⱼ.

The estimated standard error for the j-th estimated model coefficient, \hat{β}ⱼ, may be computed from the symmetric matrix

C=\hat{σ}²(X^{T}X)⁻¹

where

\hat{σ}²=MS_{E} (23b)

The estimated standard error SE(\hat{β}ⱼ)=\sqrt{Cⱼⱼ}, where Cⱼⱼ the j-th diagonal element of the matrix C. The null hypothesis is rejected when the t-test satisfies the following condition:

−Th_{T}<Tⱼ<Th_{T} (23c)

In other words, when the condition in Equation (23c) is satisfied, the event-type probabilities Xⱼ is related to the KPI Y. The threshold Th_{T} may be preselected by a user. Alternatively, the threshold may be set to the t-distribution:

Th_{T}=t_{γ,n-2} (23d)

The subscript γ is a non-zero probability that may be set to a value less than or equal to 0.10 (i.e., 0<γ<1 and γ is the area of the tails of the t-distribution computed with degrees of freedom L−2). Alternatively, when the following condition is satisfied

Tⱼ≤−Th_{T} or Th_{T}≤Tⱼ (23e)

the event-type probabilities Xⱼ is not related to the KPI Y (i.e., is irrelevant) and the estimated model coefficient \hat{β}ⱼ is set to zero in the parametric model. When one or more event-type probabilities have been identified as being unrelated to the KPI Y, the estimated model coefficients may be recalculated according to Equation (20) with the irrelevant event-type probabilities omitted from the design matrix \tilde{X} and corresponding model coefficients omitted from the process. The resulting parametric model is the trained parametric inference model.

In another implementation, the analytic engine 312 may execute a backward stepwise selection process to train a parametric model that contains only relevant event-type probabilities. The backward stepwise process employs a step-by-step process of eliminating irrelevant event-type probabilities from the set of event-type probabilities and thereby produces a parametric model that has been trained with relevant event-type probabilities. For each historical time window, the process partitions the event-type probabilities and the KPI into a training set and a validating set.

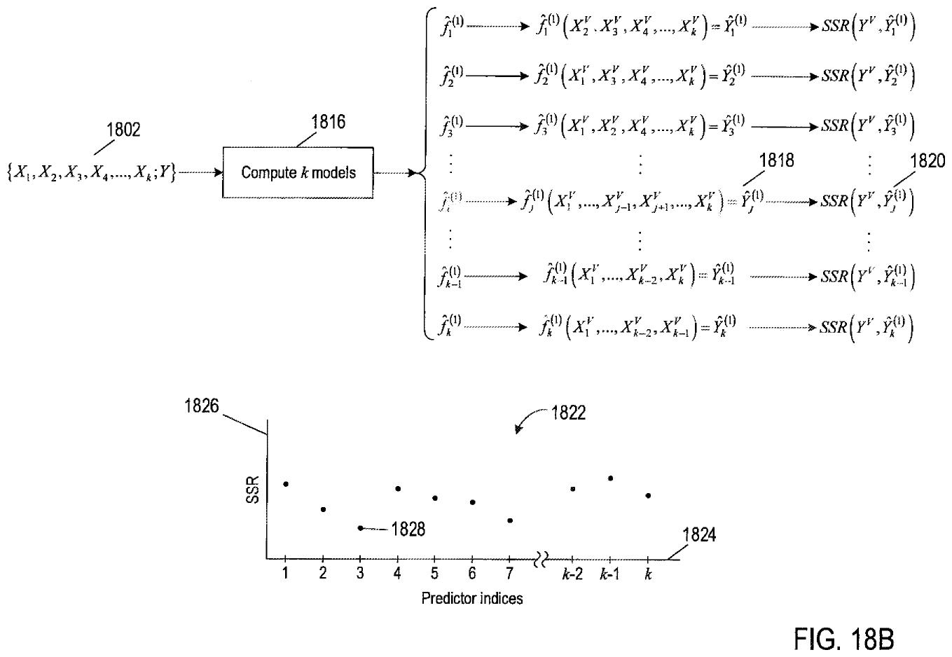

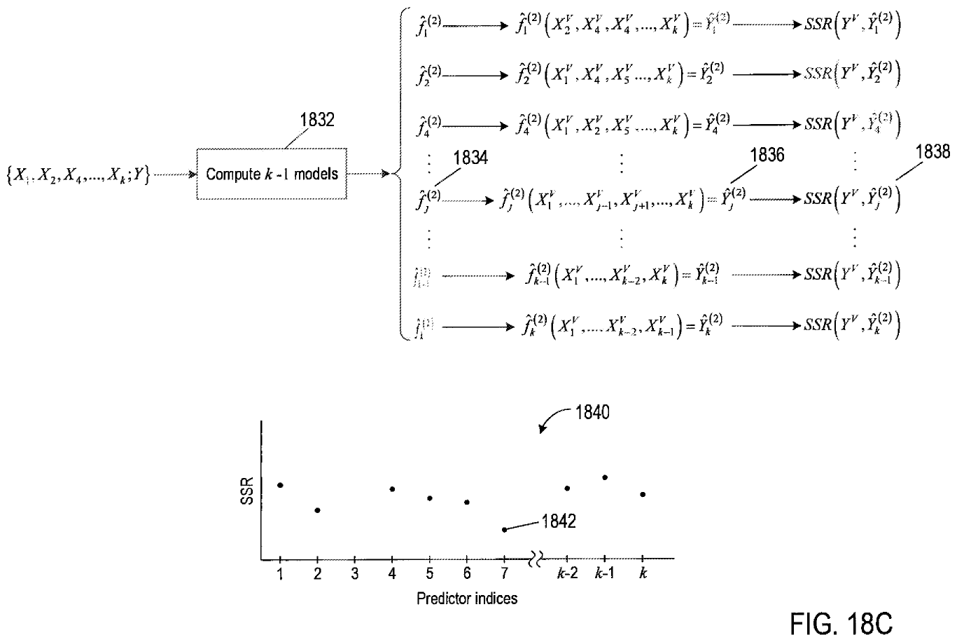

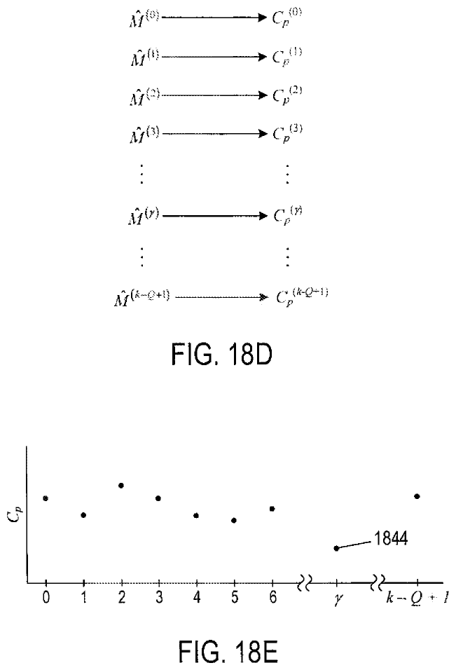

FIG. 18A shows an example of partitioning a set of event-type probabilities and a KPI recorded in the historical time window [tₛ, tᵢ] into a training set and validating set of event-type probabilities. The set of event-type probabilities and the KPI recorded in the historical time window TWᵢ, also represented by interval [tₛ, tᵢ], are partitioned to form a training set of event-type probabilities 1802 and KPI 1804 recorded in a subinterval [tₛ, tₙ] 1806 and a validating set of event-type probabilities 1808 and KPI 1810 recorded in a subinterval (tₙ, tᵢ] 1812, where tₙ denotes a midpoint time in the interval [tₛ, tᵢ], and a superscript V is added to distinguish the validating set from the training set. The training set is composed of event-type probabilities of event types that occurred in the subinterval [tₛ, tₙ] 1806. The validating set is composed of event-type probabilities of event types that occurred in the subinterval (tₙ, tᵢ] 1812.

A full model \hat{M}⁽⁰⁾ is initially computed with the full training set using least squares as described above with reference to Equations (20) and (21), where superscript (0) indicates that none of the k event-type probabilities have been omitted from the training set in determining the model \hat{M}⁽⁰⁾ (i.e., \hat{M}⁽⁰⁾=\hat{f}). For each step q=j, j−1, . . . , Q, a set of models denoted by {\hat{f}₁^{(γ)},\hat{f}₂^{(γ)}, . . . ,\hat{f}_{q}^{(γ)}} is computed using least squares as described above with reference to Equations (20) and (21) but with a different event-type probabilities omitted from the training set for each model, where γ=1, 2, . . . , j−Q+1 represents the number of event-type probabilities that have been omitted from the training set and Q is a user selected positive integer less than k (e.g., Q=1). At each step q, an estimated KPI, \hat{f}ⱼ^{(γ)}(X^{V})=Ŷⱼ^{(γ)}, is computed using the event-type probabilities of the validating set for each of the q models to obtain a set of estimated KPIs {Ŷ₁^{(γ)},Ŷ₂^{(γ)}, . . . ,Ŷ_{q}^{(γ)}}. A sum of squared residuals (“SSR”) is computed for each estimated KPI and the KPI of the validating set as follows:

$$SSR ( {Y}^{V} , {\hat{Y}}_{j}^{( γ )} ) = {\sum }_{i = 1}^{L} {( {y}_{i}^{V} - {\hat{y}}_{ij}^{( γ )} )}^{2} \qquad ( 24 )$$

where
yᵢ^{V} is the i-th KPI value in the KPI Y^{V};
ŷᵢⱼ^{(γ)} is the i-th KPI value in the estimated KPI Ŷⱼ^{(γ)}; and
j=1, . . . , q.
   Let \hat{M}^{(γ)} denote the model, such as model \hat{f}ⱼ^{(γ)}(X^{V}), with the smallest corresponding SSR is denoted by

SSR(γ)=min{SSR(Y^{V},Ŷ₁^{(γ)}), . . . ,SSR(Y^{V},Ŷ_{q}^{(γ)})}

The stepwise process terminates when q=Q. For each step q, the resultant model \hat{M}^{(γ)} has been determined for q−γ event-type probabilities that produce the smallest errors. The final model \hat{M}^{(p-Q+1)} is determined with Q−1 event-type probabilities that have the smallest SSRs. The stepwise process produces a set of models denoted by M={\hat{M}⁽⁰⁾, \hat{M}⁽¹⁾, . . . , \hat{M}^{(p-Q+1)}}. Except for the full model \hat{M}⁽⁰⁾, each of the models in the set M has been computed by omitting one or more event-type probabilities Xⱼ. The model in the set M with the best fit to the validating set is determined by computing a Cₚ-statistic for each model in the set M as follows:

$${C}_{p}^{( γ )} = \frac{1}{n} ( S S R ( γ ) + 2 d {\hat{σ}}^{2} ) \qquad ( 25 )$$

where
d is the number of metrics in the corresponding model \hat{M}^{(γ)};
\hat{σ}² is the variance of the full model \hat{M}⁽⁰⁾ given by Equation (23b); and
j=1, . . . , p−Q+1.
   The Cₚ-statistic for the full model \hat{M}⁽⁰⁾ is given by SSR(Y^{V}, Ŷ₁⁽⁰⁾). The parametric model with the smallest corresponding Cₚ-statistic is the resulting trained parametric model.

FIGS. 18B-18E show an example of training a model using the backward stepwise process described above. In FIG. 18B, for a first step q=k, block 1816 represents computing a set of k models. {\hat{f}₁⁽¹⁾, \hat{f}₂⁽¹⁾, . . . ,\hat{f}ₖ⁽¹⁾}. Model \hat{f}ⱼ⁽¹⁾ is computed using least squares as described above with reference to Equations (20) and (21) with the event-type probabilities Xⱼ omitted from the training set 1802 for j=1, . . . ,k. Estimated KPIs are computed for each of the k models {Ŷ₁⁽¹⁾, Ŷ₂⁽¹⁾, . . . , Ŷₖ⁽¹⁾}, where Ŷⱼ⁽¹⁾ 1818 is computed for \hat{f}ⱼ⁽¹⁾ using least squares as described above with reference to Equations (20) and (21) with the metric Xⱼ^{V} omitted from the validating set. An SSR is computed for each of the models according to Equation (24). For example, SSR(Y^{V},Ŷⱼ⁽¹⁾) 1820 is computed for the model \hat{f}ⱼ⁽¹⁾ in accordance with Equation (24). FIG. 18B includes a plot 1822 of example SSR values for the k models. Horizontal axis 1824 represents the event-type probability indices. Vertical axis 1826 represents a range of SSR values. Points represent the SSR values for the k models. In this example plot, point 1828 is the minimum SSR that corresponds to the model \hat{f}₃⁽¹⁾, where the event-type probabilities X₃ have been omitted from the training set 1802. The resulting model for the first step is \hat{M}⁽¹⁾=\hat{f}₃⁽¹⁾. As a result, the event-type probabilities X₃ is regarded as irrelevant and discarded from the training set 2008 prior to proceeding to the next step with q=k−1.

In FIG. 18C, for a second step q=k−1, block 1832 represents computing a set of k−1 models. {\hat{f}₁⁽²⁾,\hat{f}₂⁽²⁾,\hat{f}₄⁽²⁾ . . . ,\hat{f}ₖ⁽²⁾}, where the model coefficient, \hat{β}₃, associated with irrelevant event-type probabilities X₃ has been omitted. Model \hat{f}ⱼ⁽²⁾ 1834 is computed using least squares as described above with reference to Equations (20) and (21) with the event-type probabilities X₃ and Xⱼ omitted from the training set 1802. Estimated KPIs are computed for each of the k−1 models, {Ŷ₁⁽²⁾, Ŷ₂⁽²⁾, Ŷ₄⁽²⁾, . . . ,Ŷₖ⁽²⁾}, where Ŷⱼ⁽²⁾ 1836 is computed using \hat{f}ⱼ⁽²⁾ with the event-type probabilities X₃^{V} and Xⱼ^{V} omitted from the validating set 1808. An SSR is computed for each of the models according to Equation (24). For example, SSR(Y^{V}, Ŷⱼ⁽²⁾) 1838 is computed for the model \hat{f}ⱼ⁽²⁾ in accordance with Equation (24). FIG. 18C includes a plot 1840 of example SSR values for the k−1 models. In this example plot, point 1842 is the minimum SSR that corresponds to the model \hat{f}₇⁽²⁾. The resulting model for the second step is \hat{M}⁽²⁾=\hat{f}₇⁽²⁾. As a result, the event-type probabilities X₇ is regarded as irrelevant and discarded from the training set 1802 prior to proceeding to the next step with q=p−2.

The stepwise process of removing irrelevant event-type probabilities is repeated for q=k−2, . . . , Q to obtain a set of candidate models M={\hat{M}⁽⁰⁾,\hat{M}⁽¹⁾, . . . , \hat{M}^{(k-Q+1)}}. A Cₚ-statistic is computed for each of the models in the set M as described above with reference to Equation (25). FIG. 18D shows Cₚ-statistics obtained for each of the models. FIG. 18E shows a plot of an example Cₚ-statistics. The parametric model associated with the minimum of the Cₚ-statistics is the trained parametric inference model. In this example, point 1844 represents the minimum Cₚ-statistics, indicating that corresponding parametric model \hat{M}^{(γ)} is the trained parametric inference model.

In another implementation, the analytics engine 312 performs cross validation to obtain a trained parametric inference model. With cross validation, the set of event-type probabilities {Xⱼ}ⱼ₌₁^{k} and corresponding KPI Y recorded in a historical time window are randomized and divided into N_{f} groups called “folds” of approximately equal size, where N_{f} is a positive integer. A fold is denoted by (Xₗ, Yₗ), where X̅ₗ⊂X, Yₗ ⊂Y, the overbar denotes a subset of event-type probabilities X̅ₗ and corresponding KPI Y̅ₗ and subscript l is a fold index with l=1, . . . , N_{f}. For each fold l, (X̅ₗ,Y̅ₗ) is treated as a validating set, and a parametric model denoted by \hat{f}ₗ is fit to the remaining N_{f}−1 folds using least squares described above Equations (20) and (21). For the l-th fold, an estimated KPI is computed with \hat{f}ₗ(X̅ₗ)=Ŷₗ. A mean squared error (“MSE”) is computed for the estimated KPI and the KPI of the validating set as follows:

$$M S E ( {\hat{Y}}_{l} , {\overline{Y}}_{l} ) = \frac{1}{L} {\sum }_{i = 1}^{L} {( {\overline{y}}_{i l} - {\hat{y}}_{i l} )}^{2} \qquad ( 26 a )$$

where
y̅ᵢₗ is the i-th KPI value of the validating KPI Y̅ₗ; and
ŷᵢₗ is the i-th KPI value of the estimated KPI Ŷₗ.
   The mean square errors are used to compute a N_{f}-fold cross-validation estimate:

$$C {V}_{{N}_{f}} = \frac{1}{{N}_{f}} {\sum }_{l = 1}^{{N}_{f}} M S E ( {\hat{Y}}_{l} , {\overline{Y}}_{l} ) \qquad ( 26 b )$$

When the N_{f}-fold cross validation estimate satisfies the condition

CV_{N}_{_{f}}<Th_{CV} (26c)

where Th_{CV} is a user-defined threshold (e.g., Th_{CV}=0.10 or 0.15), for each of the parametric models {\hat{f}₁, . . . , \hat{f}_{N}_{_{f}}}, model coefficients of a trained parametric model are obtained by averaging the model coefficients of the N_{f} models as follows:

$${\hat{β}}_{j} = \frac{1}{{N}_{f}} {\sum }_{i = 1}^{{N}_{f}} {\hat{β}}_{jl} for j = 0 , 1 , … , k . \qquad ( 26 d )$$

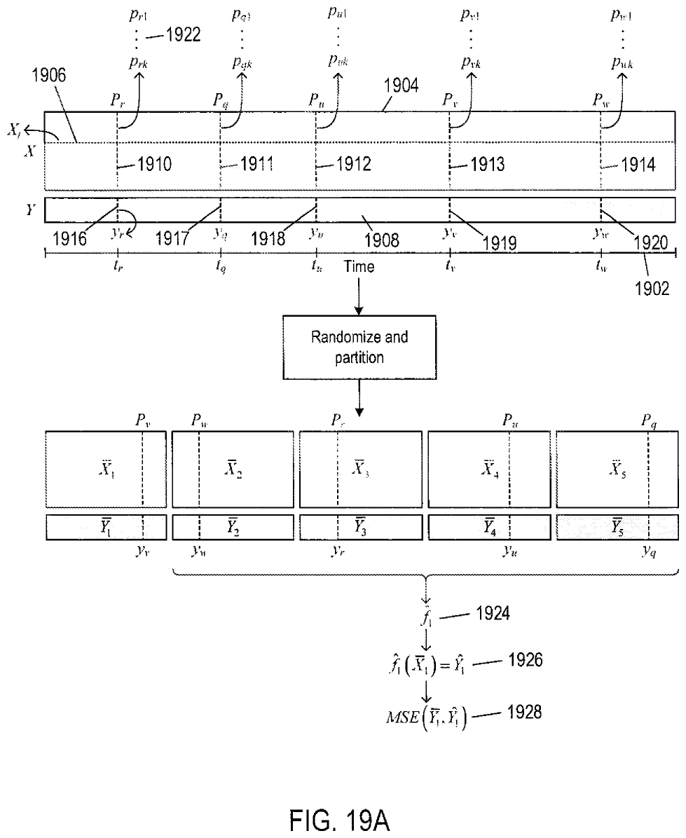

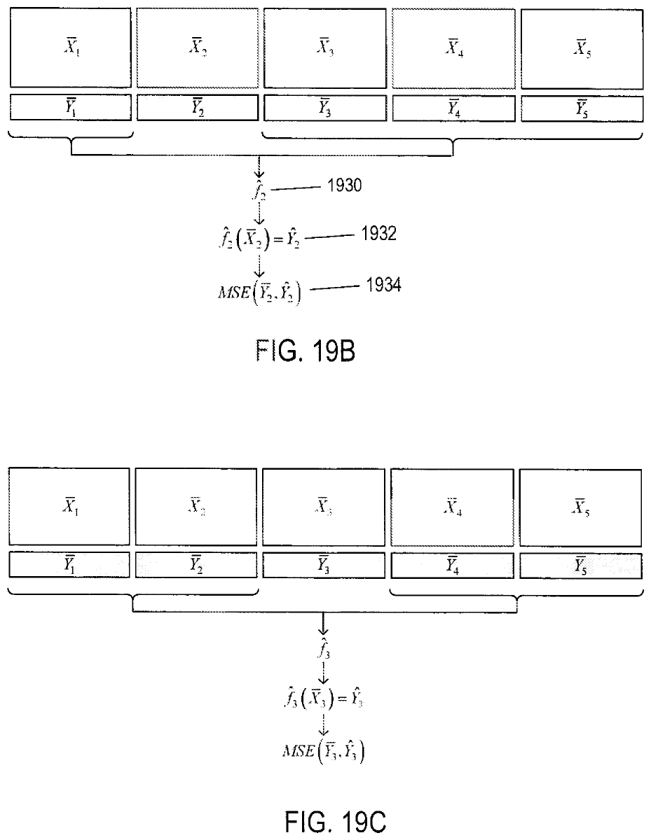

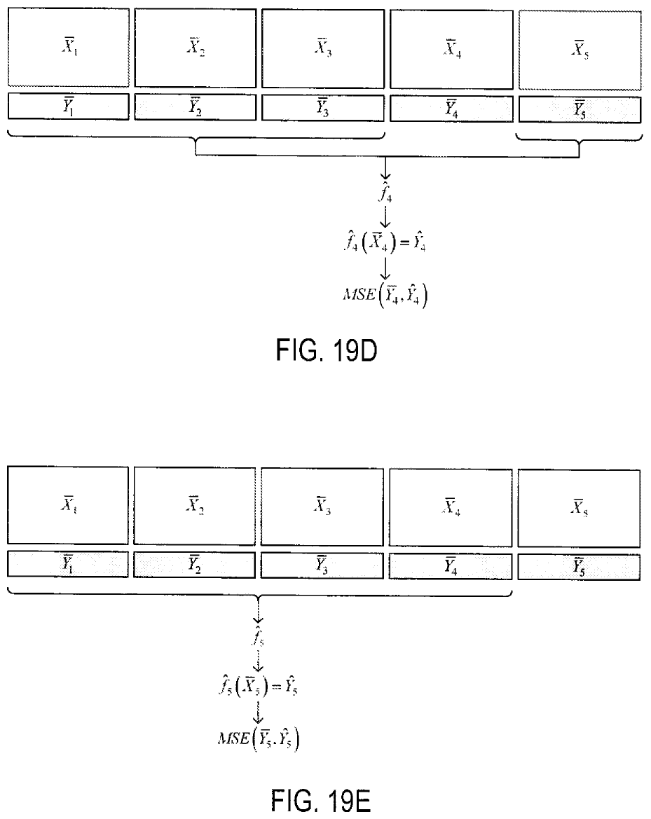

FIGS. 19A-19E show of an example of N_{f}-fold cross validation applied to an example set of event-type probabilities and KPI values for N_{f}=5 (i.e., 5 folds). In FIG. 19A, line 1902 represents a historical time period. Block 1904 represents event-type probabilities X recorded in the historical time period 1902. For example, dotted line 1906 represents event-type probabilities Xⱼ for an event type Eⱼ occurring over the time period 1902. Shaded block 1908 represents KPI values for a KPI recorded in the time period 1902. Dashed lines 1910-1914 denote probabilities of time stamps tᵣ, t_{q}, tᵤ, tᵥ, and t_{w}. Dashed lines 1916-1918 represent KPI values yᵣ, y_{q}, yᵤ, yᵥ, and y_{w} with corresponding the time stamps tᵣ, t_{q}, tᵤ, tᵥ, and t_{w}. For example, dashed line 1910 represents event-type distribution Pᵣ with probabilities 1922 of k event types associated with a KPI value yᵣ recorded at time stamp tᵣ. In this example, the event-type distributions and corresponding KPI values at the same time stamps are randomized and partitioned into 5-folds. The event-type distributions of the 5-folds are denoted by X̅₁, X̅₂, X̅₃, X̅₄, and X̅₅ (i.e., X̅₁ ∪X̅₂ ∪X̅₃ ∪X̅₄ ∪X̅₅=X) and the corresponding KPIs are denoted by Y̅₁, Y̅₂, Y̅₃, Y̅₄, and Y̅₅ (i.e., Y̅₁ ∪Y̅₂ ∪Y̅₃ ∪Y̅₄ ∪Y̅₅=Y). Randomization scrambles the event-type distributions and corresponding KPI values. For example, randomization places the event-type distribution Pᵣ 1910 and corresponding KPI value y₁ 1916 in the third fold (X̅₃, Y̅₃). For the first iteration in FIG. 19A, the first fold (X̅₁, Y̅₁) is the validating set and a parametric model \hat{f}₁ 1924 is obtained as described above with reference to Equations (19) and (20) using the folds (X̅₂,Y̅₂), (X̅₃,Y̅₃), (X̅₄,Y̅₄), and (X̅₅,Y̅₅) as a training set. The trained model \hat{f}₁ is applied to the event-type distribution X̅₁ to obtain an estimated KPI Ŷ₁ 1926. A mean square error MSE(Ŷ₁,Y̅₁) 1928 is computed for the estimated KPI Ŷ₁ and the KPI Y̅₁ of the first fold. For the second iteration in FIG. 19B, the second fold (X̅₂, Y̅₂) is the validating set and a model \hat{f}₂ 1930 is trained as described above with reference to Equations (19) and (20) using the folds (X̅₁, Y̅₁), (X̅₃, Y̅₃), (X̅₄, Y̅₄), and (X̅₅, Y̅₅) as a training set. The trained model \hat{f}₂ is applied to the event-type distribution X̅₂ to obtain an estimated KPI Ŷ₂ 1932. A mean square error MSE(Ŷ₂,Y̅₂) 1934 is computed for the estimated KPI Ŷ₂ and the KPI Y̅₂ of the second fold. In FIGS. 19C-19E, the same process is repeated where each of the folds (X̅₃, Y̅₃), (X̅₄,Y̅₄), and (X̅₅,Y̅₅) is used separately as a validating set to obtain corresponding parametric models \hat{f}₃, \hat{f}₄, and \hat{f}₅ and corresponding mean square errors MSE(Ŷ₃,Y̅₃), MSE(Ŷ₄,Y̅₄), and MSE(Ŷ₅, Y̅₅). A 5-fold cross-validation estimate, CV₅, is computed as described above with reference Equation (26b). If the 5-fold cross-validation estimate satisfies the condition in Equation (26c), a trained parametric model is computed with estimated model coefficients computed as described above with reference to Equation (26d).

In another implementation, ridge regression may be used to compute estimated model coefficients {\hat{β}ⱼ^{R}}ⱼ₌₁^{k} that minimizes

$${\{ {\hat{β}}_{j}^{R} \}}_{j = 1}^{k} = {\sum }_{i = 1}^{L} {( {y}_{i} - {β}_{0} - {\sum }_{j = 1}^{k} {β}_{j} {x}_{ij} )}^{2} \qquad ( 27 a )$$

subject to the constraint that

$${\sum }_{j = 1}^{k} {β}_{j}^{2} \leq λ \qquad ( 27 b )$$

where λ≥0 is a tuning parameter that controls the relative impact of the coefficients. The estimated model coefficients are computed using least squares with

\hat{β}^{R}=(X^{T}X+λI_{k×k})⁻¹X^{T}Y (28)

where I_{k×k} is the k×k identity matrix for different values of the tuning parameter λ. A set of event-type distributions and a KPI recorded over a historical time window are partitioned to form a training set and a validating set as described above with reference to FIG. 19A. A set of models, {\hat{f}^{(λ)}}, are computed for different tuning parameters according to Equation (27a)-(27b). The models are used to compute a set of corresponding estimated KPIs {Ŷ^{(λ)}} for each of the tuning parameters. The parametric model that gives the smallest SSR value computed according to Equation (24) is the trained parametric inference model.

In still another implementation, lasso regression may be used to compute estimated model coefficients {\hat{β}ⱼ^{L}}ⱼ₌₁^{p} that minimizes

$${\{ {\hat{β}}_{j}^{L} \}}_{j = 1}^{k} = argmin \{ {\sum }_{i = 1}^{L} {( {y}_{i} - {β}_{0} - {\sum }_{j = 1}^{k} {β}_{j} {x}_{ij} )}^{2} \} \qquad ( 29 a )$$

subject to the constraint that

$${\sum }_{j = 1}^{k} \vert {β}_{j} \vert \leq s \qquad ( 29 b )$$

where s≥0 is a tuning parameter. Computation of the estimated model coefficients {\hat{β}ⱼ^{L}}ⱼ₌₁^{k} is a quadratic programming problem with linear inequality constraints as described in “Regression Shrinkage and Selection via the Lasso.” by Robert Tibshirani. J. R. Statist. Soc. B (1996) vol. 58, no. 1, pp. 267-288.

A trained parametric inference model can be used to compute an estimated KPI value of an actual KPI value, y, as a function of an event-type distribution. P, that is associated with the KPI value as follows:

$$\hat{y} = {f}^{t} ( P ) - {\tilde{P}}^{T} \hat{B} \qquad ( 30 )$$

$$where P = [ \begin{matrix}{p}_{1} \\ ⋮ \\ {p}_{k}\end{matrix} ] ;$$

$$\tilde{P} = [ \begin{matrix}1 \\ {p}_{1} \\ \begin{matrix}⋮ \\ {p}_{k}\end{matrix}\end{matrix} ] ; and$$

$$\hat{B} = [ \begin{matrix}{\hat{β}}_{0} \\ {\hat{β}}_{1} \\ \begin{matrix}⋮ \\ {\hat{β}}_{k}\end{matrix}\end{matrix} ] .$$

The superscript “T” denotes transpose. The matrix \hat{B} denotes estimated model coefficients obtain using any of the training techniques described above.

The parametric inference models described above are computed based on a linear relationship between event-type distributions and KPI values. However, in certain cases, the relationship between event-type distributions and a KPI is not linear. A cross-validation error estimate, denoted by CVₑᵣᵣₒᵣ, may be used to determine whether a parametric inference model is suitable or a non-parametric inference model should be used instead. When the cross-validation error estimate satisfies the condition CVₑᵣᵣₒᵣ<Thₑᵣᵣₒᵣ, where Thₑᵣᵣₒᵣ is an error threshold (e.g., Thₑᵣᵣₒᵣ=0.1 or 0.2), the parametric inference model is used. Otherwise, when the cross-validation error estimate satisfies the condition CVₑᵣᵣₒᵣ≥Thₑᵣᵣₒᵣ, a non-parametric inference model is computed as described below. For the N_{f}-fold cross validation, the CVₑᵣᵣₒᵣ=CVₖ, described above with reference to Equation (26b). For the other parametric inference models described above, the CVₑᵣᵣₒᵣ=MSE(Ŷ, Y^{V}), where Ŷ is the estimated KPI computed for a validating set of event-type probabilities X^{V} and validating KPI Y^{V}.

Non-Parametric Inference Model

In cases where a parametric inference model is not suitable, the analytics engine 312 trains a non-parametric inference model using K-nearest neighbor regression. K-nearest neighbor regression is performed by first determining an optimum positive integer number. K, of nearest neighbor event-type distributions associated with the KPI values.

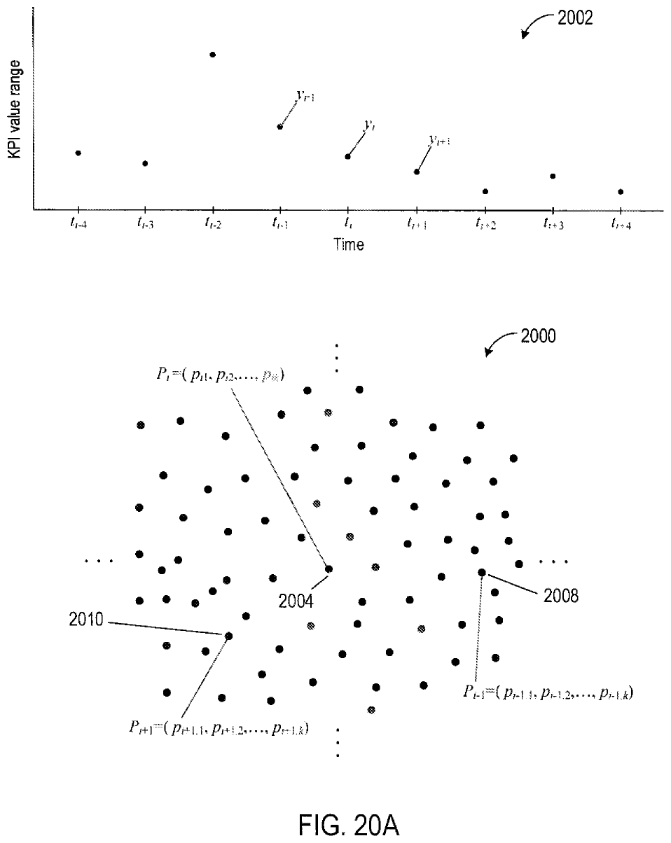

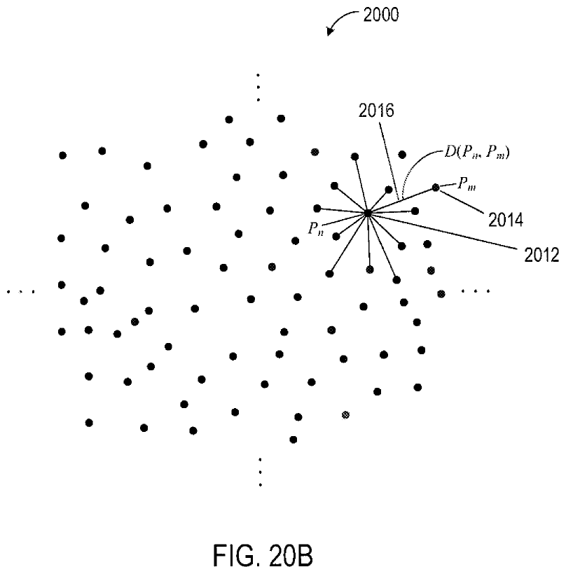

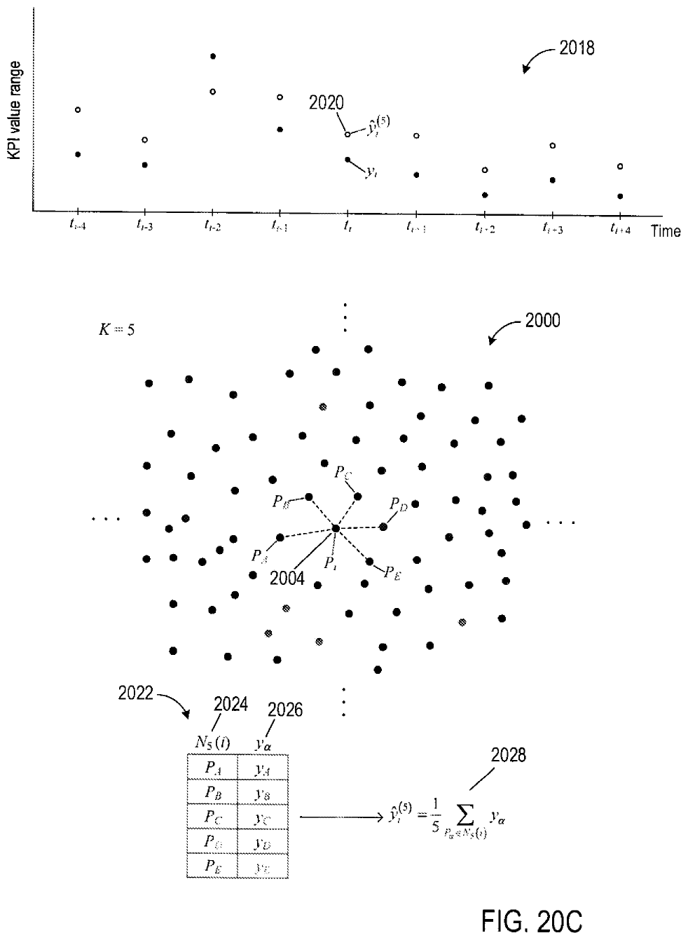

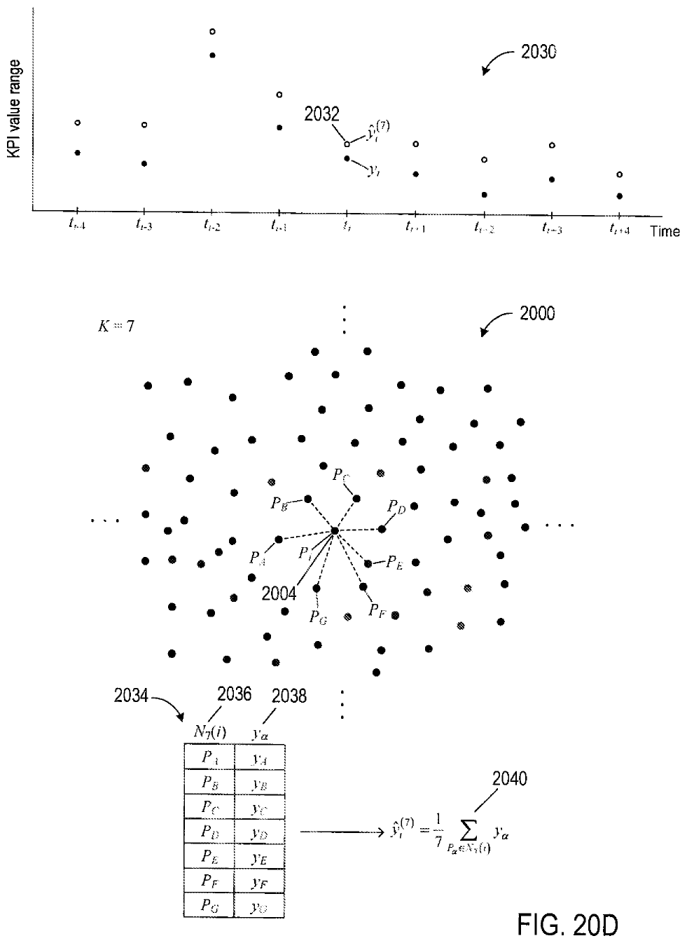

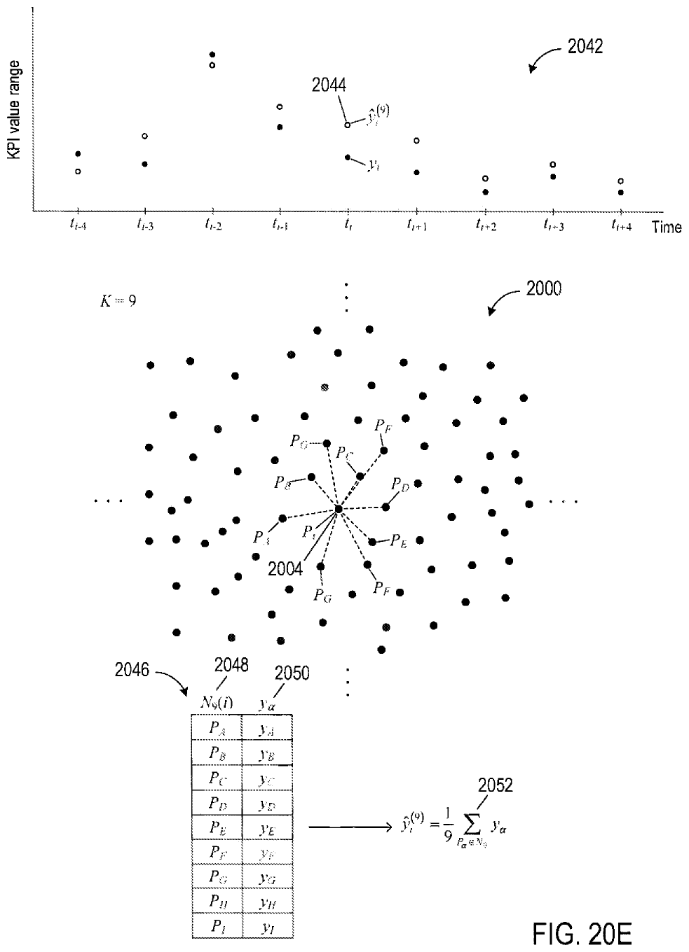

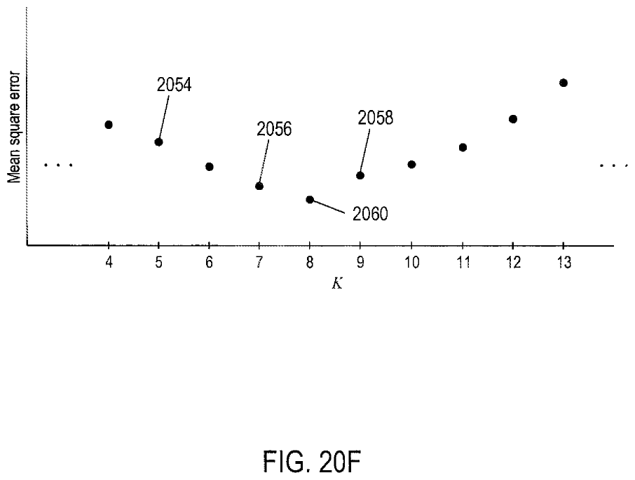

FIGS. 20A-20F show an example of determining a K-nearest neighbor regression model. FIG. 20A shows an example of event-type distributions represented by points in a k-dimensional event-type distribution space 2000 and a plot 2002 of corresponding KPI values of the KPI shown in FIG. 14. Each event-type distribution is a k-tuple of probabilities of k event types that are represented by a point in the k-dimensional space 2000 and correspond to KPI value and time stamp in plot 2002. For the sake of convenience, the k-dimensional space 2000 is shown in 2-dimensions. For example, point 2006 represents k probabilities of event-type distribution Pᵢ and corresponds to KPI value yᵢ at a time stamp tᵢ in the plot 2002. Point 2008 represents k probabilities of event-type distribution Pᵢ₋₁ and corresponds to KPI value yᵢ₋₁ at a time stamp tᵢ₋₁ in the plot 2002. Point 2010 represents k probabilities of event-type distribution Pᵢ₊₁ and corresponds to KPI value yᵢ₊₁ at a time stamp tᵢ₊₁.

The operations management server 132 computes the distance between each pair of the event-type distributions in the k-dimensional space 2000. In one implementation, the distance is computed between a pair of event-type distributions Pₘ and Pₙ using a cosine distance for m,n=1, . . . , L:

$${D}_{CS} ( {P}_{m} , {P}_{n} ) = \frac{2}{π} {cos}^{- 1} [ \frac{{\sum }_{j = 1}^{k} {p}_{mj} {p}_{nj}}{\sqrt{{\sum }_{j = 1}^{k} {( {p}_{mj} )}^{2}} \sqrt{{\sum }_{j = 1}^{k} {( {p}_{nj} )}^{2}}} ] \qquad ( 31 a )$$

where m≠n. The closer the distance D_{CS}(Pₘ, Pₙ) is to zero, the closer the event-type distributions Pₘ and Pₙ are to each other in the k-dimensional space 2000. The closer the distance D_{CS}(Pₘ, Pₙ) is to one, the farther distributions Pₘ and Pₙ are from each other in the k-dimensional space 2000. In another implementation, the distance between event-type distributions Pₘ and Pₙ is computed using the Jensen-Shannon divergence for m, n=1, . . . , L (m≠n):

$${D}_{JS} ( {P}_{m} , {P}_{n} ) = - {\sum }_{j = 1}^{k} {M}_{j} {log}_{2} {M}_{j} + \frac{1}{2} [ {\sum }_{j = 1}^{k} {p}_{mj} {log}_{2} {p}_{mj} + {\sum }_{j = 1}^{k} {p}_{nj} {log}_{2} {p}_{nj} ] \qquad ( 31 b )$$

$$where {M}_{j} = ( {p}_{mj} + {p}_{nj} ) / 2$$

The Jensen-Shannon divergence ranges between zero and one. The closer D_{JS}(Pₘ, Pₙ) is to zero, the closer the distributions Pₘ and Pₙ are to one another in the k-dimensional space 2000. The closer D_{JS}(Pₘ, Pₙ) is to one, the farther distributions Pₘ and Pₙ are from each other in the k-dimensional space 2000. In the following discussion, the distance D(Pₘ, Pₙ) represents the distance D_{CS}(Pₘ, Pₙ) or the distance D_{JS}(Pₘ, Pₙ).

FIG. 20B shows an example of distances between an event-type distribution Pₙ neighboring event-type distributions in the k-dimensional space 2000. Point 2012 represents k probabilities of the event-type distribution Pₙ. Line segments connecting the event-type distribution P₁ to neighboring event-type distributions represent distances between the event-type distribution and the neighboring event-type distributions. For example, point 2014 represents probabilities of an event-type distribution Pₘ. Line segment 2016 represents the distance D(Pₘ, Pₙ).

K-nearest neighbor regression optimizes the number of K KPI values that can be used to estimate KPI values. Let N_{K}(i) denote a set of K nearest-neighbor (i.e., closest) event-type distributions to the event-type distribution Pᵢ in the historical time period, where Pᵢ∈N_{K}(i). For an initial value K, an estimated KPI value ŷᵢ of KPI value yᵢ is computed by averaging K KPI values that correspond to K nearest-neighbor event-type distributions to the event-type distribution Pᵢ:

$${\hat{y}}_{i}^{( K )} = \frac{1}{K} {\sum }_{{P}_{α} ∈ {N}_{K} ( i )} {y}_{α} \qquad ( 32 )$$

where
superscript (K) denotes the number of K nearest neighbors; and
y_{α} is a KPI value with a corresponding event-type distribution P_{α} in the set N_{K}(i).
   The process of computing an estimated KPI value for each KPI value in the historical time period is performed with a fixed K. An MSE is computed for the value K as follows:

$$MSE ( K ) = \frac{1}{L} {\sum }_{i = 1}^{L} {( {y}_{i} - {\hat{y}}_{i}^{( K )} )}^{2} \qquad ( 33 )$$

The operations represented by Equations (32) and (33) are repeated for different values of K. The value of K with the minimum MSE is the optimum K denoted by K_{O}. The trained K-nearest neighbor regression model for estimating KPI values is given by:

$${\hat{y}}_{i} = \frac{1}{{K}_{O}} {\sum }_{{P}_{α} ∈ {N}_{{K}_{O}} ( q )} {y}_{α} \qquad ( 34 )$$

where
ŷᵢ is an estimated KPI value of a KPI value yᵢ; and
N_{K}_{_{O}}(q) is a set of K_{O} nearest-neighbor event-type distributions to the event-type distribution Pᵢ associated with the KPI value yᵢ.

FIGS. 20C-20F illustrate construction of an example K-nearest neighbor model. FIG. 20C shows a plot 2018 of example estimated KPI values computed for a subset of the KPI values in the plot 1400. In this example, the estimated KPI values are computed for K=5 nearest neighbor event-type distributions in the k-dimensional space 2000. A set N₅(l) of the 5 nearest neighbor event-type distributions and estimated KPI value ŷₗ⁽⁵⁾ is determined for each of the KPI values yₗ, where l=1, . . . , L. The estimated KPI values of the KPI values are represented by open dots. For example, estimated KPI value ŷᵢ⁽⁵⁾ 2020 of the KPI value yᵢ is computed by averaging the KPI values in the historical time period with the 5-nearest neighbor event-type distributions to the event-type distribution Pᵢ 2004 in the k-dimensional space 2000. Five dashed lines connect the event-type distribution Pᵢ 2004 to the 5-nearest neighbor event-type distributions that form the set N₅(i), which are denoted by P_{A}, P_{B}, P_{C}, P_{D}, and P_{E}. FIG. 20C includes a table 2022 with the 5 event-type distributions in the set N₅(i) listed in the column 2024 and corresponding KPI values listed in column 2026. The estimated KPI value ŷᵢ⁽⁵⁾ 2020 is computed according to equation 2028. An MSE, MSE(5), is computed for the estimated KPI values and the corresponding KPI values according to Equation (22).

FIG. 20D shows a plot 2030 of example estimated KPI values computed for a subset of the KPI values in the plot 1400. In this example, the estimated KPI values are computed for K=7 nearest neighbor event-type distributions in the k-dimensional space 2000. A set N₇(l) of the 7 nearest neighbor event-type distributions and estimated KPI value ŷₗ⁽⁷⁾ is determined for each of the KPI values yₗ, where l=1, . . . , L. The estimated KPI values of the KPI values are represented by open dots. For example, estimated KPI value ŷᵢ⁽⁷⁾ 2032 of the KPI value yᵢ is computed by averaging the KPI values in the historical time period with the 7-nearest neighbor event-type distributions to the event-type distribution Pᵢ 2004 in the k-dimensional space 2000. Seven dashed lines connect the event-type distribution Pᵢ 2004 to the 7-nearest neighbor event-type distributions that form the set N₇(i), which are denoted by P_{A}, P_{B}, P_{C}, P_{D}, P_{E}, P_{F}, and P_{G}. FIG. 20D includes a table 2034 with the 7 event-type distributions in the set N₇(i) listed in the column 2036 and corresponding KPI values listed in column 2038. The estimated KPI value ŷᵢ⁽⁷⁾ 2032 is computed according to equation 2040. An MSE, MSE(7), is computed for the estimated KPI values and the corresponding KPI values according to Equation (22).

FIG. 20E shows a plot 2042 of example estimated KPI values computed for a subset of the KPI values in the plot 1400. In this example, the estimated KPI values are computed for K=9 nearest neighbor event-type distributions in the k-dimensional space 2000. A set N₉(l) of the 9 nearest neighbor event-type distributions and estimated KPI value ŷₗ⁽⁹⁾ is determined for each of the KPI values yₗ, where l=1, . . . , L. The estimated KPI values of the KPI values are represented by open dots. For example, estimated KPI value ŷᵢ⁽⁹⁾ 2044 of the KPI value yᵢ is computed by averaging the KPI values in the historical time period with the 9-nearest neighbor event-type distributions to the event-type distribution Pᵢ 2004 in the k-dimensional space 2000. Nine dashed lines connect the event-type distribution Pᵢ 2004 to the 9-nearest neighbor event-type distributions that form the set N₉(i), which are denoted by P_{A}, P_{B}, P_{C}, P_{D}, P_{E}, P_{F}, P_{G}, P_{H}, and P_{I}. FIG. 20E includes a table 2046 with the 9 event-type distributions in the set N₉(i) listed in the column 2048 and corresponding KPI values listed in column 2050. The estimated KPI value ŷᵢ⁽⁹⁾ 2042 is computed according to equation 2052. An MSE, MSE(9), is computed for the estimated KPI values and the corresponding KPI values according to Equation (22).

FIG. 20F shows a plot of MSE values versus values of K. Solid dots represent MSE values for K ranging from 5 to 13. Dot 2054, 2056, and 2058 represent MSEs MSE(5), MSE(7), and MSE(9), respectively. In this example, dot 2060 represents the minimum MSE MSE(8). As a result, the optimum K that relates the event-type distributions and KPI values is K=8. In this example, the trained 8-nearest neighbor regression model for estimating KPI values is given by:

$${\hat{y}}_{q} = \frac{1}{8} {\sum }_{{P}_{α} ∈ {N}_{8} ( q )} {y}_{α}$$

The analytics engine 312 uses the trained inference model (i.e., parametric inference model or non-parametric inference model) associated with the KPI to determine the relative importance of the event-type probabilities. The analytics engine 312 first determines relative importance scores of the event types based on associated event-type probabilities then rank orders the event types based on the corresponding relative importance scores of the event-type probabilities. In the case of a linear relationship between the event-type distributions and the KPI, the analytics engine 312 computes an estimated provisional KPI Ŷₘ for each event-type probabilities, Xₘ, omitted from the set of event-type probabilities {Xⱼ}ⱼ₌₁^{k}, where the subscript m=1, . . . , k. For each m, the analytics engine 312 computes an estimated provisional KPI using the trained parametric model for the KPI Y:

\hat{f}^{t}({Xⱼ}ⱼ₌₁^{k}−Xₘ)=Ŷₘ (35)

where
the symbol “-” denotes omission of the event-type probabilities Xₘ from the set of event-type probabilities {Xⱼ}ⱼ₌₁^{k}; and
\hat{f}^{t}(⋅) denotes the trained inference model.

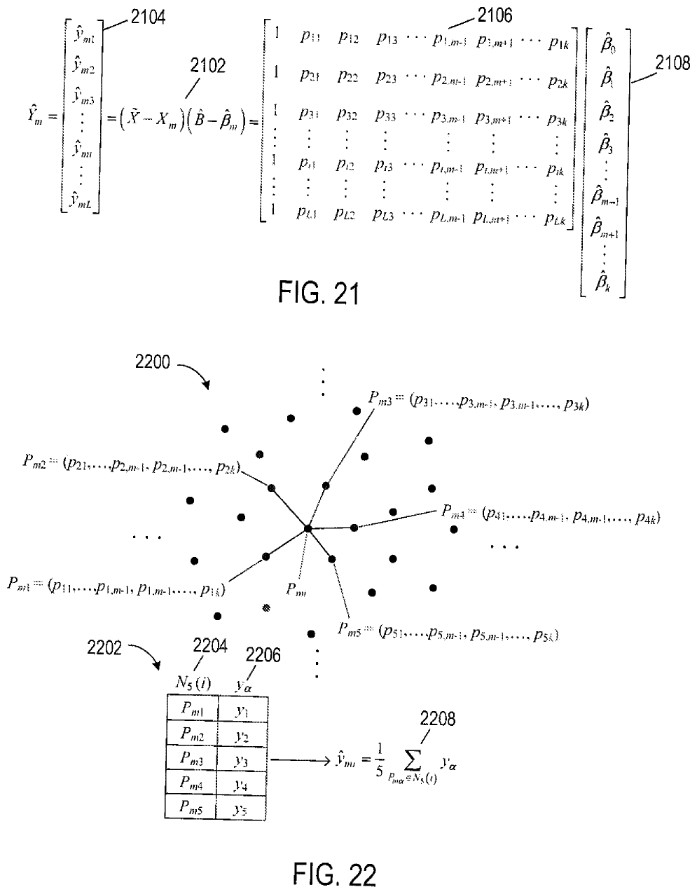

FIG. 21 shows an example of a trained parametric inference model 2202 used to compute an estimated provisional KPI Ŷₘ 2204. The model 2202 includes a reduced design matrix (\tilde{X}−Xₘ) 2206 formed by omitting event-type probabilities Xₘ from the design matrix \tilde{X}. The model 2202 includes a reduced model coefficients matrix (\hat{B}−\hat{β}ₘ) 2208 formed by omitting corresponding estimated model coefficient \hat{β}ₘ from the model coefficient matrix \hat{B}. The estimated provisional KPI Ŷₘ 2204 is computed by multiplication of the matrices 2206 and 2208 for m=1, . . . , k.

In the case of a nonlinear relationship between the event-type distributions and the KPI, analytics engine 312 computes an estimated provisional KPI Ŷₘ by omitting the event-type probabilities, Xₘ, from the set of event-type distributions {Pᵢ}ᵢ₌₁^{L}, which reduces the event-type distribution space from k dimensions to k−1 dimensions. For example, for i=1, . . . , L, the k-dimensional event-type distributions are reduced k−1 dimensional event-type distributions as follows

Pᵢ=(pᵢ₁, . . . p_{i,m-1},pᵢₘ,p_{i,m+1}. . . ,pᵢₖ)→(pᵢ₁, . . . p_{i,m-1},p_{i,m+1}. . . pᵢₖ)=Pₘᵢ

The analytics engine 312 computes the estimated provisional KPI values of Ŷₘ using the trained K-nearest neighbor regression model in Equation (34) for K-nearest neighbor event-type distributions in the k−1 dimensional event-type distribution space. The i-th estimated KPI value, ŷₘᵢ, of the estimated provisional KPI Ŷₘ is computed from K_{O} KPI values associated with the K_{O} reduced event-type distributions that are closest to the reduced event-type distribution Pₘᵢ in the k−1 dimensional space. For each m=1, . . . , k, the estimated KPI values ŷₘᵢ are computed for i=1, . . . , L to obtain the estimated provisional KPI Ŷₘ. Note that the set of K_{O} KPI values used to compute the estimated KPI value, ŷᵢ, in the k-dimensional space may not be the same set of K_{O} KPI values used to compute the estimated provisional KPI value, ŷₘᵢ, in the k−1 dimensional space because the distances between event-type distributions in the k−1 dimensional space are different from than distances between event-type distributions in the k-dimensional space.

FIG. 22 shows a portion of k−1 dimensional space 2200. In this example, suppose training has determined that K_{O}=5. The i-th estimated KPI value, ŷₘᵢ, of the estimated provisional KPI Ŷₘ is computed from 5 KPI values associated with the 5 reduced event-type distributions, denoted by Pₘ₁, Pₘ₂, Pₘ₃, Pₘ₄, and Pₘ₅, that are closest to the reduced event-type distribution Pₘᵢ. Each of these event-type distributions is missing a probability for the m-th event type Eₘ. FIG. 22 includes a table 2202 with the 5 event-type distributions in the set N₅(i) listed in the column 2204 and corresponding KPI values listed in column 2206. The estimated KPI value ŷₘᵢ is computed according to Equation 2208.

The analytics engine 312 computes a root MSE (“RMSE”), RMSE(Ŷₘ, Y), for each estimated provisional KPI (i.e., RMSE(Ŷₘ, Y)=\sqrt{MSE(Ŷₘ,Y)}). Each RMSE indicates the degree to which the KPI depends on event-type probabilities Xₘ. In other words, the RMSE indicates the degree to which the KPI depends on the event type Eₘ associated with the event-type probabilities Xₘ. An omitted event-type probabilities Xₘ with a larger associated RMSE. RMSE(Ŷₘ,Y), than the RMSE, RMSE(Ŷ_{m′},Y), of another omitted event-type probabilities X_{m′} indicates that the KPI depends on the event-type probabilities Xₘ more than the event-type probabilities X_{m′}. The analytics engine 312 determines the maximum RMSE:

RMSEₘₐₓ=max{RMSE(Ŷ₁,Y), . . . ,RMSE(Ŷₖ,Y)} (36)

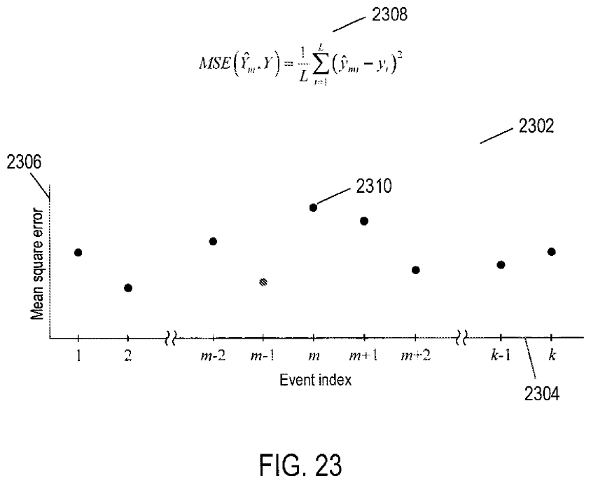

FIG. 23 shows an example plot 2302 of RMSEs computed for a number of the estimated provisional KPIs. Horizontal axis 2304 represents the range of event-type probability indices. Vertical axis 2306 represents the range of values for the mean square errors. Solid dots represent RMSE values for different event-type probability index values. FIG. 23 shows an RMSE 2308 computed with elements of the estimated provisional KPI Ŷₘ 2304 and elements of the KPI Y. In this example, RMSEₘₐₓ is represented by solid dot 2310.

The analytics engine 312 computes a relative importance score for each of event type Eⱼ as follows:

$${I}_{j}^{score} = \frac{RMSE ( {\hat{Y}}_{j} , Y )}{{RMSE}_{max}} \times 100 \qquad ( 37 )$$

where j=1, . . . , k. A threshold for identifying the highest largest relative importance scores is given by the condition:

Iⱼ^{score}>Th_{score} (38)

where Th_{score} is a user defined score threshold. For example, the user-defined threshold may be set to 80%, 70% or 60%. The relative importance score Iⱼ^{score} computed in Equation (37) is assigned to the corresponding event type Eⱼ. The event types are rank ordered based on the corresponding relative importance scores to identify the highest ranked event types that impact the KPI. An event type with a relative importance score that satisfies the condition in Equation (38) is called an “important event type.” For example, the highest ranked event types are important event types with relative importance scores above the user-defined threshold Th_{score}.

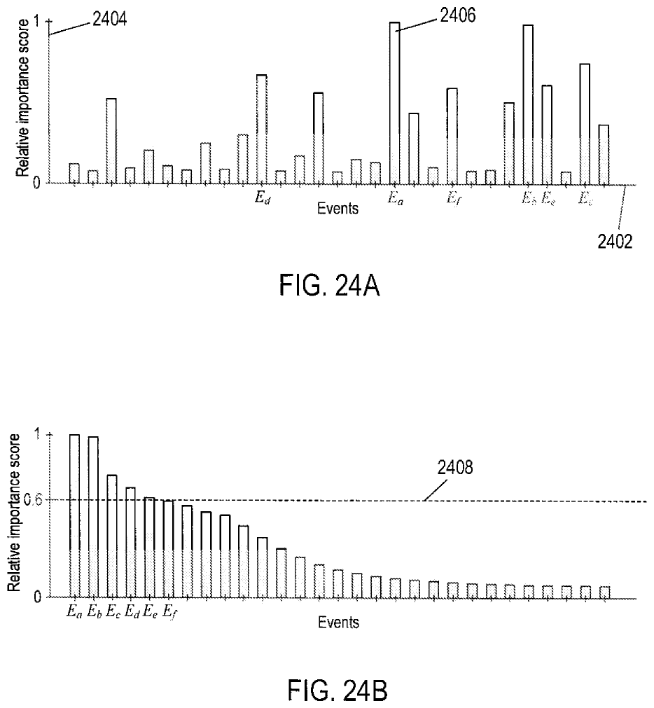

FIG. 24A shows a plot of example relative importance scores for a series of event types. Horizontal axis 2402 represents the event types observed for an application in the historical time period. Vertical axis 2404 represents the range of relative importance scores. Bars represent the relative importance scores associated with the event types. For example, bar 2406 represents the relative importance score for the event type denoted Eₐ.

FIG. 24B shows a plot of the example relative importance scores rank ordered from largest to smallest. Dashed line 2408 represents a score threshold set to 0.6. The event types Eₐ, E_{b}, E_{c}, E_{d}, and Eₑ have relative importance scores that are greater than the score threshold and are identified as important event types. The important event types are used to identify potential root causes of performance problems reveal by the KPI. The event types with relative importance scores less that the score threshold, such as event type E_{f}, are regarded as unlikely to be related to the potential root cause of a performance problem.

Any one or a combination of the event types Eₐ, E_{b}, E_{c}, E_{d}, and Eₑ could a potential root cause of a performance problem detected by the associated KPI. The relative importance scores provide an indication as to which event types are of greater relevance in determining a potential root cause. For example, the plot of example relative importance scores in FIG. 24B reveals that event type Eₐ is the most important event type as the potential root cause of the performance problem with the KPI. The event type E_{b} is the second most important event type as the potential root cause of the performance problem with the KPI. The event type Eₑ is the least important of important event types as the potential root cause of the performance problem with the KPI.

In one implementation, the analytics engine 312 computes whisker maximum and whisker minimum of the probabilities of the important event types in the historical time period. The analytics engine 312 computes probabilities of the important event types in the run-time interval and compares the probabilities to corresponding whisker maximum and whisker minimum to determine the important event types in the run-time interval is an outlier (i.e., atypically high, atypically low, or in a typical range). The outlier important event types are more likely the root cause of the performance problem.

Suppose an event type Eⱼ is has been identified as an important event type with a relative importance score Iⱼ^{score} that satisfies the condition in Equation (37). The event-type probabilities for the important event type Eⱼ in the historical time period are given by:

$${X}_{j} = [ \begin{matrix}{p}_{1 j} \\ \begin{matrix}⋮ \\ {p}_{ij}\end{matrix} \\ \begin{matrix}⋮ \\ {p}_{Lj}\end{matrix}\end{matrix} ]$$

The analytic engine 312 partitions the event-type probabilities Xⱼ into quartiles, where Q₂ denotes the median of all the event-type probabilities Xⱼ, Q₁ denotes a lower median of the event-type probabilities that are less than the median Q₂, and Q₃ denotes an upper median of the event-type probabilities that are greater than the median Q₂. The medians Q₁, Q₂, and Q₃ partition the range of event-type probabilities Xⱼ into quartiles such that 25% of the event-type probabilities are greater than Q₃, 25% of the event-type probabilities are less than Q₁, 25% of the event-type probabilities lie between Q₁ and Q₂, and 25% of the event-type probabilities lies between Q₂ and Q₃. Fifty percent of the event-type probabilities lie in the interquartile range:

IQR=Q₃−Q₁ (39)

The interquartile range is used to compute a whisker minimum given by

Min=Q₁−B×IQR (40a)

and a whisker maximum given by

Max=Q₃+B×IQR (40b)

where B is a constant greater than 1 (e.g., B=1.5).

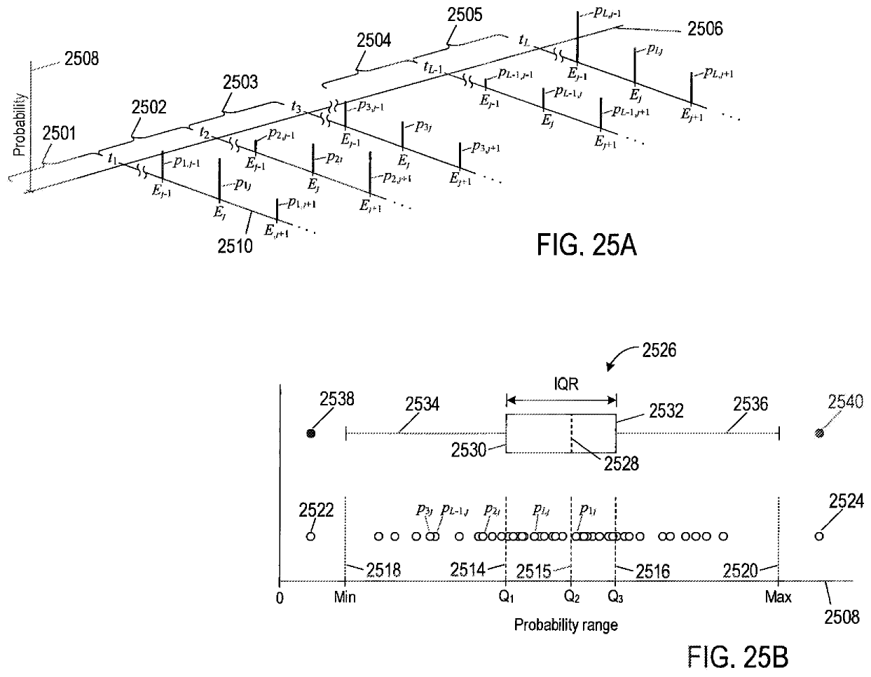

FIG. 25A shows plots of example probabilities of event-type distributions produced in historical time intervals 2501-2505 of the historical time period. Axis 2506 represents time. Axis 2508 represents a range of probabilities. Axes extending perpendicular to the time axis 2506 each represent the range of event types. Bars extending above the event-type axes represent probabilities associated with the event types. For example, axis 2510 represents three event types labeled Eⱼ₋₁, Eⱼ, and Eⱼ₊₁ and the corresponding probabilities are denoted by p_{1,j-1}, p_{1,j}, and p_{1,j+1}. The probabilities of the event types are determined for the historical time windows as described above with reference to Equation (15) and shown in FIG. 15B. The event-type probabilities Xⱼ of the event type Eⱼ occurring in the time windows 2501-2505 are denoted by p_{1,j}, p_{2,j}, p_{3,j}, p_{L-1,j}, and p^{L,j}.

FIG. 25B shows a plot of the event-type probabilities Xⱼ of FIG. 25A partitioned into quartiles. FIG. 25B includes probability axis 2508. Open dots represent event-type probabilities Xⱼ determined in the historical time period. For example, open dots labeled p_{1,j}, p_{2,j}, p^{3,j}, p_{L-1,j}, and p_{L,j} correspond to the probabilities p_{1,j}, p_{2,j}, p_{3,j}, P_{L-1,j}, and p_{L,j} in FIG. 25A. Dashed lines 2514-2516 correspond to the medians Q₁, Q₂, and Q₃ of the event-type probabilities Xⱼ. Dotted line 2518 and 2520 correspond to the whisker minimum and whisker maximum computed according to Equations (40a) and (40b). In this example, open dots 2522 and 2524 are outlier probabilities of the event-type probabilities Xⱼ. FIG. 25B includes a boxplot 2526 that represents the spread, or distribution, of event-type probabilities Xⱼ. Dashed line 2528 corresponds to the median Q₂. Sides 2530 and 2532 of the box correspond to lower median Q₁ and upper median Q₃. Lengths of whiskers 2534 and 2536 correspond to the whisker minimum and whisker maximum that define the limits of the normal range of event-type probabilities Xⱼ for the event type Eⱼ. Shaded dots 2538 and 2540 correspond to the outlier event-type probabilities 2522 and 2524. The event-type probability 2524 is an atypically high event-type probability. The event-type probability 2522 is an atypically low probability. Event-type probabilities between the whicker maximum and the whisker minimum are in the normal range.

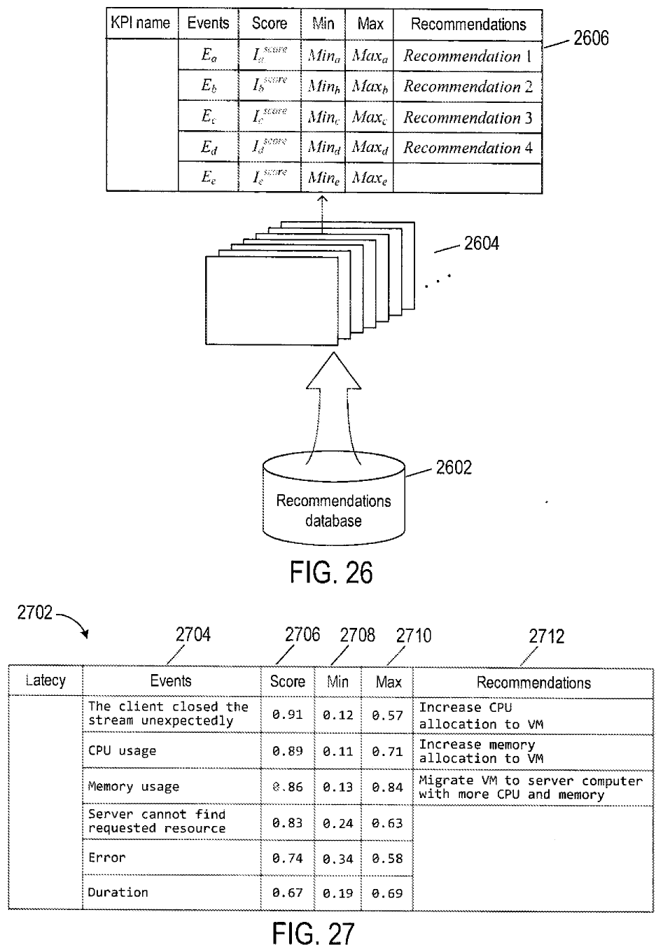

The controller 310 stores the event types, relative importance scores, whicker minima and maxima, and recommendations for remedying performance problems with each KPI of the applications executing in a data center in a recommendations database. FIG. 26 shows an example of structured information content of a recommendations database 2602. The database 2602 electronically stores the event types, relative importance scores, whicker minima and maxima, and recommendations for remedying performance problems with each KPI in separate data tables 2604. In the example of FIG. 26, data table 2606 contains the event types, relative importance scores, whicker minima and maxima, and recommendations for a KPI of an application.

FIG. 27 shows example contents of a data table 2702 for a latency KPI of an application executing in a data center. In this example, the latency KPI has six associated important event types listed in column 2704, associated relative importance scores listed in column 2706, whisker minima and maxima listed in columns 2708 and 2710, and a list of recommendations that a system administrator can execute to correct performance problems with the application in column 2712. The event types and relative importance scores reveal the important event types that are a potential root cause of the performance problem. One potential root cause of the performance problem is “the client closed the stream unexpectedly” based on the relative importance score of 0.91. Another important event type that is a potential root cause of the performance problem is “CPU usage” based on the relative importance score of 0.89. The whisker minima and whisker maxima are used to determine whether run-time probabilities of important event types are atypically low or atypically high, such important event types are more likely the root cause of the performance problem.

Performance problems with an application can originate from the data center infrastructure and/or the application itself. While an application is executing in the data center, the analytics engine 312 computes KPIs of the application and compares run-time KPI values (i.e., as the KPI values are generated) to corresponding KPI thresholds to detect a run-time performance problem as described above. In response to a run-time KPI value violating a corresponding KPI threshold, the analytics engine 312 sends an alert notification to the controller 310 that a KPI threshold violation has occurred and the controller 310 directs the user interface 302 to display an alert in GUI of a system administrators console.

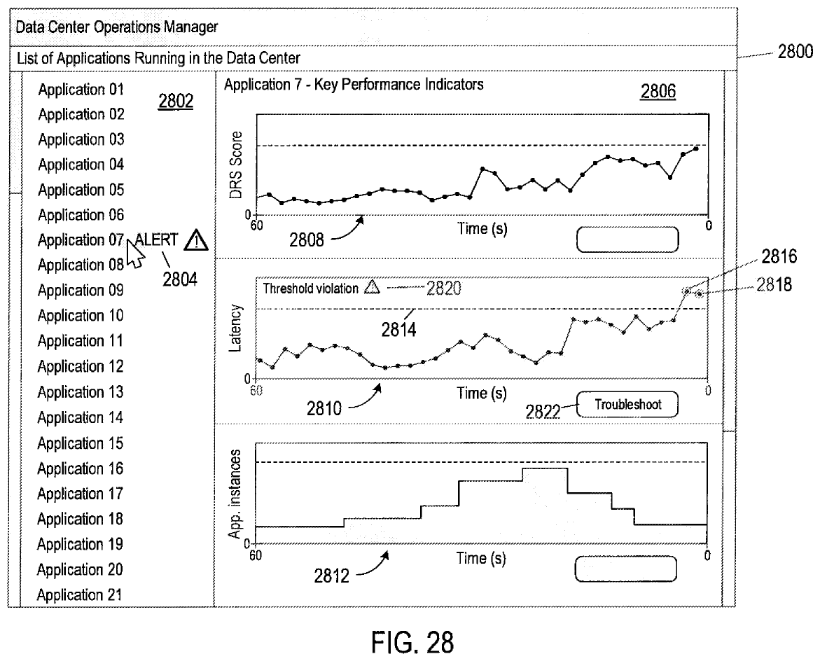

FIG. 28 shows an example GUI 2900 that displays a list of applications executing in a data center in left-hand pane 2802. Each application may have numerous KPIs that are used to monitor different aspects of the performance of an application. In this example, the application identified as “Application 07” is identified with an alert 2804. A user clicks on the highlighted area around “Application 07.” creating plots of the KPIs associated with Application 07 in right-hand pane 2806. In this example, the pane 2806 displays a plot 2808 of recent DRS scores produced in the last 60 seconds, a plot 2810 of “Application 07” latency in the last 60 seconds, and number of instances of “Application 07” in the last 60 seconds. Each plot includes an associated KPI threshold represented by a dashed line. For example, plot 2810 includes threshold 2814. The latency KPI has violated the threshold 2814 as indicated by highlighted dots 2816 and 2818, which triggered the alert 2804. In this example, an alert 2820 is displayed in the plot 2810 of the latency KPI, specifically identifying the latency threshold violation as the performance problem of “Application 07.” Each KPI has an associated troubleshoot button. In this example, because latency of the application indicates a performance problem with the “Application 07.” troubleshoot button 2822 is active. A user clicks on the troubleshoot button 2822 to start the troubleshooting process.

In response to receiving the troubleshoot command from the user interface 302, the analytics engine 312 computes probabilities of the important event types of the application in a run-time window denoted by [t_{Rs}, t_{R}], where t_{R} is the time stamp of the run-time KPI value violation of the KPI threshold. The time stamp t_{R} denotes the end time of the run-time window. The time t_{Rs} denotes the beginning of the run-time window. The duration of the run-time window is the same duration as the historical time windows described above with reference to FIG. 15A. For example, in FIG. 21, t_{R} is the time stamp of the run-time KPI value 2816. At least one of the important event types associated with the application is a potential root cause of the performance problem detected in the KPI. The analytics engine 312 narrows the focus on important event types by determining whether any of the important event types has an atypically high or atypically low run-time probability of occurrence in the run-time window. An important event type with an atypically high or atypically low run-time probability is more likely to be the root cause of the performance problem than the other important event types.

Let p_{Rj} be a run-time probability of an important event type Eⱼ. In one implementation, the analytics engine 312 compares the run-time probability p_{Rj} to the whisker minimum and the whisker maximum of the important event type Eⱼ. When the run-time probability p_{Rj} satisfies the following condition:

p_{Rj}<Min (41a)

the important event type Eⱼ is tagged as having an atypically low event-type probability. When the run-time probability p_{Rj} satisfies the following condition:

p_{Rj}>Max (41b)

the important event type Eⱼ is tagged as having an atypically high event-type probability.

In another implementation, the analytics engine 312 determines atypically high and atypically low probabilities of run-time important event types by computing a run-time Z-score for each of the important event types. The run-time Z-score of the important event type Eⱼ is given by

$${Z}_{Rj} = \frac{{p}_{Rj} - {\overline{p}}_{j}}{{σ}_{j}} where \qquad ( 42 )$$

$${\overline{p}}_{j} = \frac{1}{L} {\sum }_{i = 1}^{L} {p}_{ij}$$

$${σ}_{j} = \sqrt{\frac{1}{L} {\sum }_{i = 1}^{L} {( {p}_{ij} - {\overline{p}}_{j} )}^{2}}$$

and pᵢⱼ is an event-type probability in the event-type probabilities Xⱼ. When the run-time Z-score satisfies the condition

Z_{Rj}>Zₜₕ (43a)

the important event type Eⱼ is tagged as having an atypically high probability p_{Rj} in the run-time window. When the run-time Z-score satisfies the condition

−Z_{Rj}<−Zₜₕ (43b)

the important event type Eⱼ is tagged as having an atypically high probability p_{Rj} in the run-time window. Example values for Z-score threshold, Zₜₕ, are 2.5, 3.0, and 3.5.

The controller 310 retrieves information recorded in the recommendations database 2602 for the application identified for troubleshooting. The controller 310 directs the user interface 302 to display the important event types, relative importance scores, labels associated with atypically high or atypically low associated run-time probabilities, and the list of recommendations for correcting the problem.

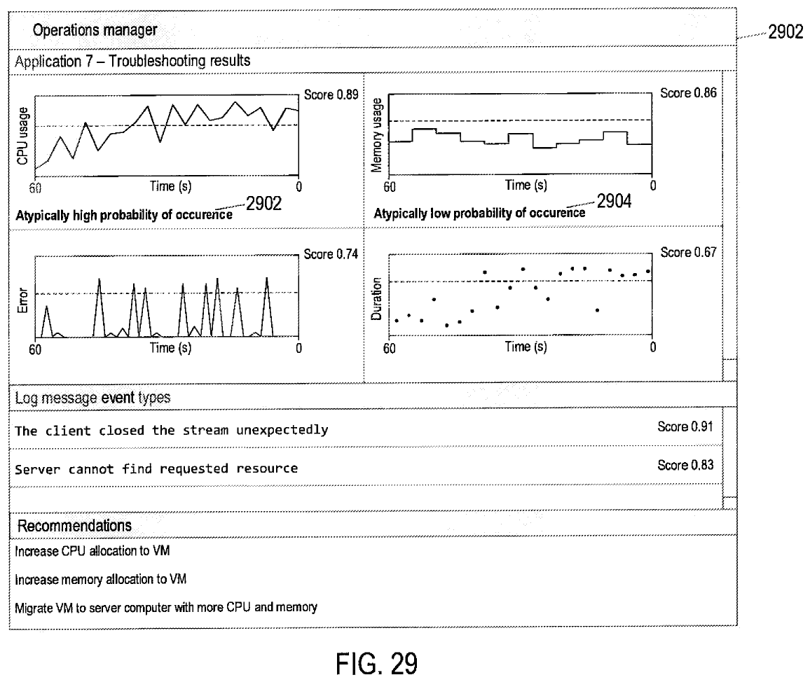

FIG. 29 shows an example GUI 2900 that displays troubleshooting results for data table 2702. In this example, the GUI 2900 displays panes for CPU usage, memory usage, errors, and duration for the last 60 seconds. Each pane includes the corresponding relative importance scores. The GUI 2900 also displays the event type and corresponding importance scores. In this example, the run-time probability associated with CPU usage is atypically high as indicated an alert 2902. The run-time probability associated with memory usage is atypically low as indicated an alert 2904. A system administrator can view the result select the appropriate remedial measures listed under Recommendations.

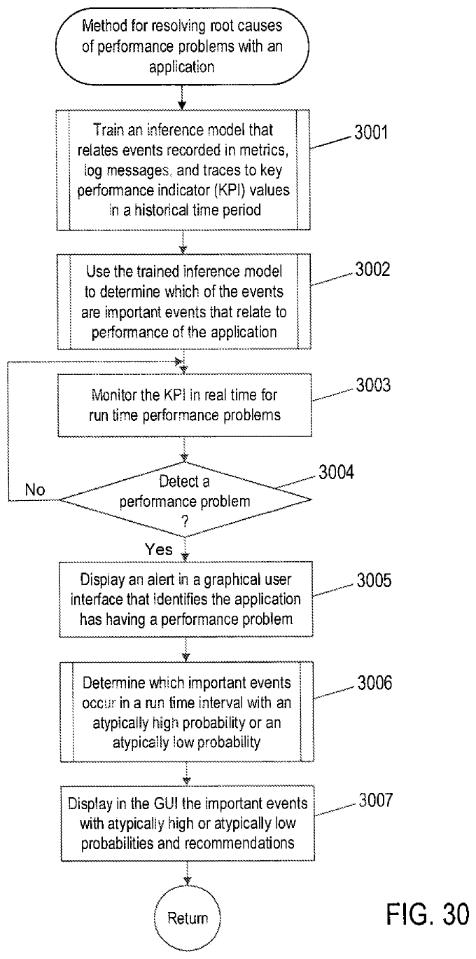

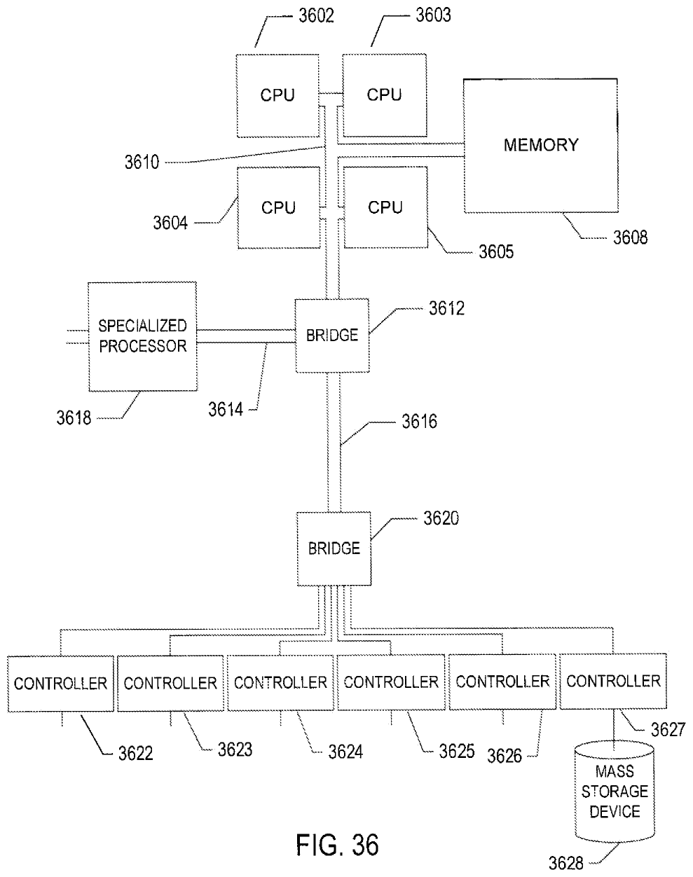

The methods described below with reference to FIGS. 30-35 are stored in one or more data-storage devices as machine-readable instructions that when executed by one or more processors of a computer system, such as the computer system shown in FIG. 36, determine the state of a data center object and, if the object exhibits abnormal behavior, identifies the potential root causes of the problem and provides a recommendation of resolving the problem. The computer-implemented process described below eliminates human errors in detecting a performance of an object in a data center and significantly reduces the amount time spent detecting problems from days and weeks to minutes and seconds, thereby providing immediate notification of a performance problem, providing at least one recommendation for correcting the problem, thereby enabling rapid execution of remedial measures that correct the problem.

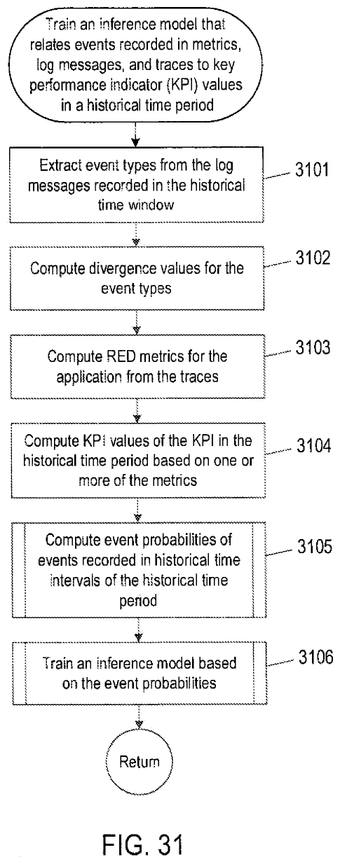

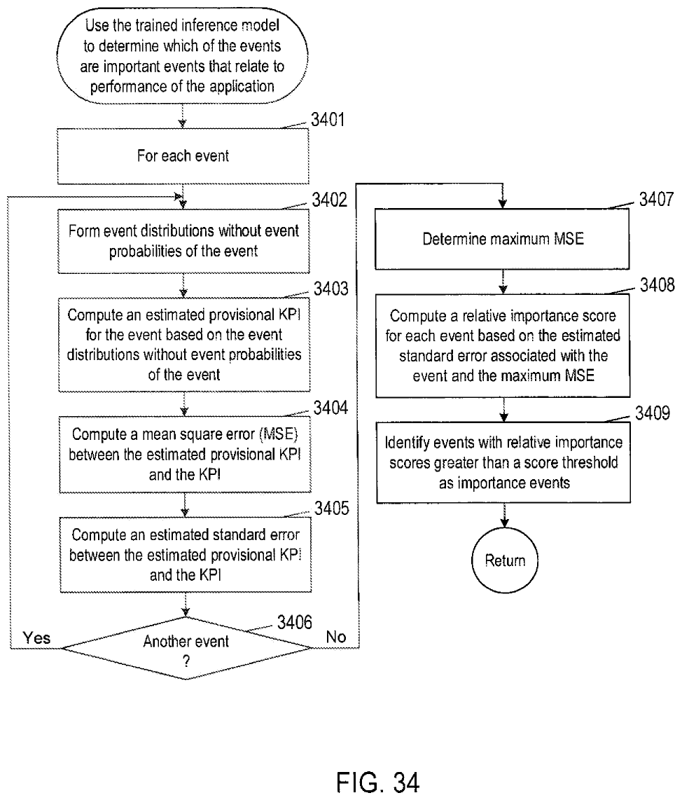

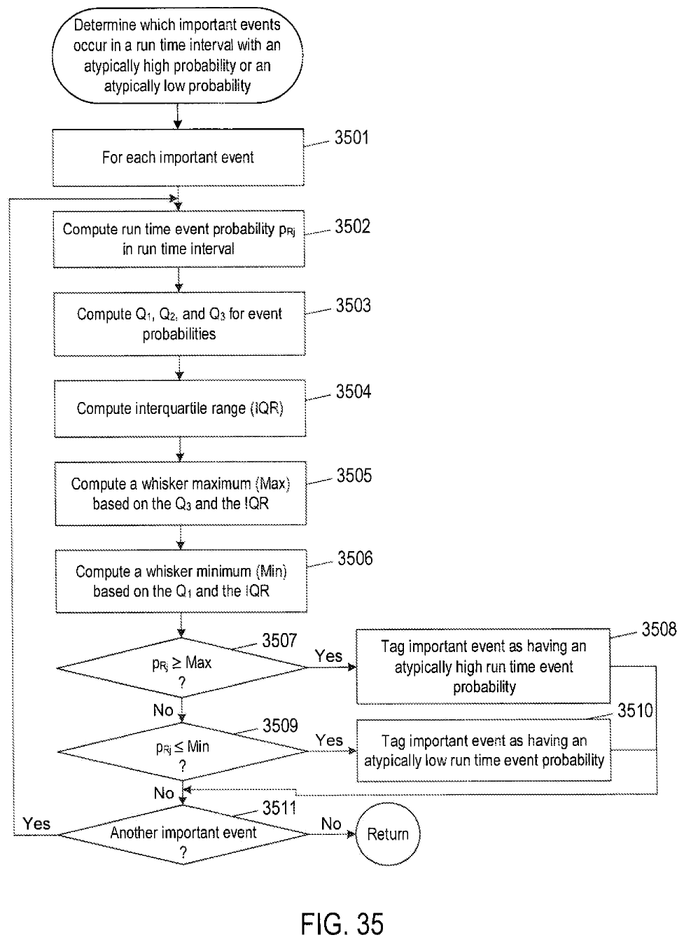

FIG. 30 is a flow diagram illustrating an example implementation of a method resolving root causes of performance problems with an application executing a data center. In block 3001, a “train an inference model that relates event types recorded in metrics, log messages, and traces to key performance indicator (KPI) values in a historical time period” procedure is performed. An example implementation of the “train an inference model that relates event types recorded in metrics, log messages, and traces to key performance indicator (KPI) values in a historical time period” is described below with reference to FIG. 31. In block 3002, a “use the trained inference model to determine which of the event types are important event types that relate to performance of the application” procedure is performed. An example implementation of the “use the trained inference model to determine which of the event types are important event types that relate to performance of the application” is described below with reference to FIG. 34. In block 3003, run-time KPI values of the KPI are monitored in by comparing each run-time KPI value to the corresponding KPI threshold. In decision block 3004, in response to the KPI value violating the KPI threshold, control flow to block 3005. In block 3005, an alert identifying the application as exhibiting performance problem is displayed in a GUI of electronic display device, such as a monitor, as described above with reference to FIG. 28. In block 3006, a “determine which important event types occur in a run-time interval with an atypically high probability or an atypically low probability” procedure is performed. An example implementation of the “determine which important event types occur in a run-time interval with an atypically high probability or an atypically low probability” is described below with reference to FIG. 35. In block 3007, the important event types with atypically high probabilities and/or atypically low probabilities are displayed in the GUI as described above with reference to FIG. 29. Recommendations for remedying the performance problems are displayed the GUI.

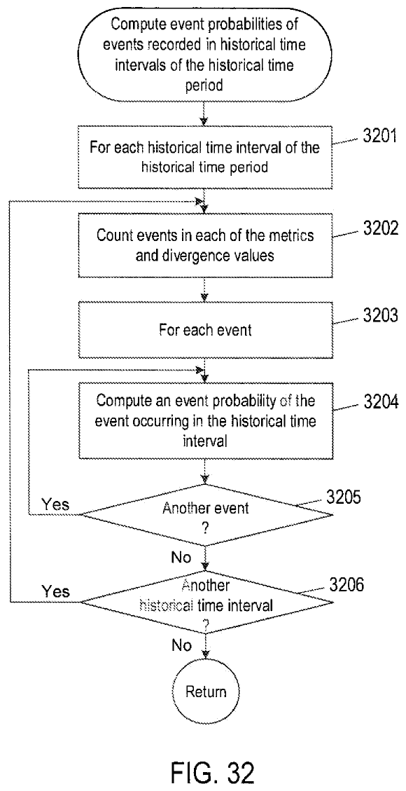

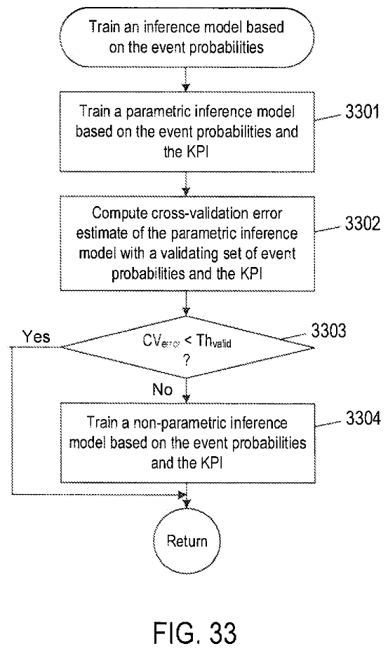

FIG. 31 is a flow diagram illustrating an example implementation of the “train an inference model that relates event types recorded in metrics, log messages, and traces to key performance indicator (KPI) values in a historical time period” procedure performed in block 3001 of FIG. 30. In block 3101, event types are extracted from log messages recorded in the historical time window as described above with reference to FIGS. 9A-9C. In block 3102, divergence values are computed as described above with reference to FIGS. 10 and 11. In block 3103, RED metrics are computed as described above with reference to FIG. 13B. In block 3104, compute KPI values of the KPI in historical time period based on one or more of the metrics. In block 3105, a “compute event-type probabilities of event types recorded in historical time intervals of the historical time period” procedure is performed. An example implementation of the “compute event-type probabilities of event types recorded in historical time intervals of the historical time period” is described below with reference to FIG. 32. In block 3106, a “train an inference model based on the event-type probabilities” procedure is performed. An example implementation of the “train an inference model based on the event-type probabilities” is described below with reference to FIG. 33.

FIG. 32 is a flow diagram illustrating an example implementation of the “compute event-type probabilities of event types recorded in historical time intervals of the historical time period” procedure performed in block 3105 of FIG. 31. A loop beginning with block 3201 repeats the computational operations represented by blocks 3202-3205 for each historical time interval of the historical time period. In block 3202, count event types in each of the metrics and divergence values as described above with reference FIG. 15A and with reference to Equation (15). A loop beginning with block 3203 repeats the computational operations represented by blocks 3204 for each event type in the historical time interval. In block 3204, an event-type probability of the event type occurring in the historical time interval is computed as described above with reference to Equation (I 5). In decision block 3205, the operation represented block 3204 is repeated for another event type. In decision block 3206, the operation represented by blocks 3202-3205 are repeated for another historical time interval.

FIG. 33 is a flow diagram illustrating an example implementation of the “train an inference model based of the event-type probabilities” procedure performed in block 3106 of FIG. 31. In block 3301, a parametric inference model is trained as described above with reference to FIGS. 17-19E. In block 3302, a cross-validation error estimate, CVₑᵣᵣₒᵣ, is computed. In decision block 3303, when CVₑᵣᵣₒᵣ≥Thₑᵣᵣₒᵣ, control flows to block 3304. In block 3304, a non-parametric inference model is computed as described above with reference to FIGS. 20A-20F.

FIG. 34 is a flow diagram illustrating an example implementation of the “use the trained inference model to determine which of the event types are important event types that relate to performance of the application” procedure performed in block 3002 of FIG. 30. A loop beginning with block 3401 repeats the computational operations represented by blocks 3402-3405 for each event type. In block 3402, event-type distributions that exclude event-type probabilities of the event type are formed as described above with reference to Equation (35). In block 3403, an estimated provisional KPI is computed for the event type based on the event-type distributions without the event-type probabilities of the event type as described above with reference to FIGS. 21 and 22. In block 3404, an MSE is computed between the estimated provisional KPI and the KPI as described above with reference to FIG. 23. In block 3405, an estimated standard error between the estimated provisional KPI and the KPI is computed. In decision block 3406, the operations represented by blocks 3402-3405 are repeated for another event type. When there are no more event types control flows to block 3407. In block 3407, a maximum MSE is determined as described above with reference to Equation (36). In block 3408, a relative importance score is computed for each of the event types based on the estimated standard error of the event type and the maximum MSE as described above with reference to Equation (37). In block 3409, event types with relative importance scores that are greater than a score threshold are identified as important event types as described above with reference to Equation (38).

FIG. 35 is a flow diagram illustrating an example implementation of the “determine which important event types occur in a run-time interval with an atypically high probability or an atypically low probability” procedure performed in block 3006 of FIG. 30. A loop beginning with block 3502 repeats the computational operations of blocks 3502-3510 for each important event type. In block 3502, a run-time event-type probability is computed for the importance event type in the run-time interval. In block 3503, the medians Q₁, Q₂, and Q₃ partition the range of event-type probabilities of the important event type are computed as described above with reference to FIG. 25B. In block 3504, an interquartile range is computed as described above with reference to Equation (39). In block 3505, a whisker maximum is computed as described above with reference to Equation (40a). In block 3506, a whisker minimum is computed as described above with reference to Equation (40b). In decision block 3507, when the run-time event-type probability is greater than the whisker maximum, control flows to block 3508. In block 3508, the important event type is tagged as having atypically high run-time event-type probability. In decision block 3509, when the run-time event-type probability is less than the whisker minimum, control flows to block 3510. In block 3510, the important event type is tagged as having atypically low run-time event-type probability. In decision block 3511, the operations represented by blocks 3502-3510 are repeated for an important event type.

FIG. 36 shows an example architecture of a computer system that may be used to host the operations management server 132 and perform the automated processes for resolving root causes of performance problems with an application executing a data center. The computer system contains one or multiple central processing units (“CPUs”) 3602-3605, one or more electronic memories 3608 interconnected with the CPUs by a CPU/memory-subsystem bus 3610 or multiple busses, a first bridge 3612 that interconnects the CPU/memory-subsystem bus 3610 with additional busses 3614 and 3616, or other types of high-speed interconnection media, including multiple, high-speed serial interconnects. The busses or serial interconnections, in turn, connect the CPUs and memory with specialized processors, such as a graphics processor 3618, and with one or more additional bridges 3620, which are interconnected with high-speed serial links or with multiple controllers 3622-3627, such as controller 3627, that provide access to various different types of computer-readable media, such as computer-readable medium 3628, electronic display devices, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 3628 is a data-storage device, which may include, for example, electronic memory, optical or magnetic disk drive, a magnetic tape drive, USB drive, flash memory and any other such data-storage device or devices. The computer-readable medium 4028 is used to store machine-readable instructions that encode the computational methods described herein.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method, stored in one or more data-storage devices and executed using one or more processors of a computer system, for resolving root causes of performance problems with an application executing in a data center, the method comprising:
using machine learning to train an inference model that relates event types recorded in metrics, log messages, and traces of the application over a historical time period to values of a key performance indicator (“KPI”) of the application recorded in the historical time period;
using the trained inference model to determine which of the event types are important event types that relate to performance of the application based on probabilities of the event types occurring in the historical time period;
in response to detecting a run-time performance problem in the KPI, determining which of the important event types occur in a run-time interval are potential root causes of the performance problem based on probabilities of the important even types occurring in the run-time interval; and
displaying an alert that identifies the application as having the run-time performance problem, identity of the important event types that are potentially the root cause of the performance problem, and at least one recommendation for remedying the performance problem in a graphical user interface (GUI) of an electronic display device.

2. The method of claim 1 wherein using machine learning to train the inference model comprises:
extracting event types from log messages recorded in the historical time window using regular expressions or Grok patterns;
computing divergence values based on the event types;
computing RED metrics for the traces of the application;
computing KPI values of the KPI in the historical time period based on one or more of the metrics;
compute event-type probabilities of event types of the metrics, divergence values, and RED metrics in historical time intervals of the historical time period; and
training the inference model based on the event-type probabilities.

3. The method of claim 1 wherein using machine learning to train the inference model comprises:
for each historical time interval of the historical time period,
counting event types in each of the metrics divergence values, and
computing an event-type probability of the event type in the historical time interval based on the count of event type.

4. The method of claim 1 wherein using machine learning to train the inference model comprises:
training a parametric inference model based on probabilities of event types in historical time intervals of the historical time period;
a cross-validation error estimate of the parametric inference model; and
computing a non-parametric inference model in response to the cross-validation error estimate being greater than a cross validation threshold.

5. The method of claim 1 wherein using the trained inference model to determine which of the event types are important event types comprises:
for each event type,
forming event-type distributions that exclude event-type probabilities of the event type,
computing an estimated provisional KPI for the event type based on the event-type distributions that exclude the event-type probabilities of the event type,
computing a mean square error (“MSE”) between the estimated provisional KPI and the KPI, and
computing an estimated standard error between the estimated provisional KPI and the KPI;
determining a maximum MSE from MSE between estimated provisional KPIs and the KPI;
computing a relative importance score for each of the event types based on the estimated standard error of the event types and the maximum MSE; and
designating event types with relative importance scores that are greater than a score threshold as important event types.

6. The method of claim wherein determining which of the important event types occur in the run-time interval comprises for each important event type:
computing a run-time event-type probability for the importance event type based on a count of the number of times the important event type occurs in the run-time interval;
computing medians that partition a range of event-type probabilities of the important into quartiles;
computing an interquartile range for the range of event-type probabilities;
computing a whisker maximum based on the interquartile range and an upper median of the range of event-type probabilities;
computing a whisker minimum based on the interquartile range and a lower median of the range of event-type probabilities;
tagging the important event type as having atypically high run-time event-type probability in response to the run-time event-type probability being greater than the whisker maximum; and
tagging the important event type as having atypically low run-time event-type probability in response to the run-time event-type probability being less than the whisker maximum.

7. The method of claim 1 wherein determining which of the important event types occur in a run-time interval are potential root causes of the performance problem comprises;
determining the probabilities of the important events in the run-time interval;
determining which of the important event types occur in a run-time interval with an atypically high probability or an atypical low probability; and
tagging the important event types with the atypically high probability or the atypical low probability as being the most likely root cause of the performance problem.

8. A computer system for identifying runtime problems with objects of a data center, the computer system comprising:
one or more processors;
one or more data-storage devices; and
machine-readable instructions stored in the one or more data-storage devices that when executed using the one or more processors control the system to performance operations comprising:
using machine learning to train an inference model that relates event types recorded in metrics, log messages, and traces of the application over a historical time period to values of a key performance indicator (“KPI”) of the application recorded in the historical time period;
using the trained inference model to determine which of the event types are important event types that relate to performance of the application based on probabilities of the event types occurring in the historical time period;
in response to detecting a run-time performance problem in the KPI, determining which of the important event types occur in a run-time interval are potential root causes of the performance problem based on probabilities of the important even types occurring in the run-time interval; and
displaying an alert that identifies the application as having the run-time performance problem, identity of the important event types that are potentially the root cause of the performance problem, and at least one recommendation for remedying the performance problem in a graphical user interface (“GUI”) of an electronic display device.

9. The system of claim 8 wherein using machine learning to train the inference model comprises:
extracting event types from log messages recorded in the historical time window using regular expressions or Grok patterns;
computing divergence values based on the event types;
computing RED metrics for the traces of the application;
computing KPI values of the KPI in the historical time period based on one or more of the metrics;
compute event-type probabilities of event types of the metrics, divergence values, and RED metrics in historical time intervals of the historical time period; and
training the inference model based on the event-type probabilities.

10. The system of claim 8 wherein using machine learning to train the inference model comprises:
for each historical time interval of the historical time period,
counting event types in each of the metrics divergence values, and
computing an event-type probability of the event type in the historical time interval based on the count of event type.

11. The system of claim 8 wherein using machine learning to train the inference model comprises:
training a parametric inference model based on probabilities of event types in historical time intervals of the historical time period;
a cross-validation error estimate of the parametric inference model; and
computing a non-parametric inference model in response to the cross-validation error estimate being greater than a cross validation threshold.

12. The system of claim 8 wherein using the trained inference model to determine which of the event types are important event types comprises:
for each event type,
forming event-type distributions that exclude event-type probabilities of the event type,
computing an estimated provisional KPI for the event type based on the event-type distributions that exclude the event-type probabilities of the event type,
computing a mean square error (“MSE”) between the estimated provisional KPI and the KPI, and
computing an estimated standard error between the estimated provisional KPI and the KPI;
determining a maximum MSE from MSE between estimated provisional KPIs and the KPI;
computing a relative importance score for each of the event types based on the estimated standard error of the event types and the maximum MSE; and
designating event types with relative importance scores that are greater than a score threshold as important event types.

13. The system of claim 8 wherein determining which of the important event types occur in the run-time interval comprises for each important event type:
computing a run-time event-type probability for the importance event type based on a count of the number of times the important event type occurs in the run-time interval;
computing medians that partition a range of event-type probabilities of the important into quartiles;
computing an interquartile range for the range of event-type probabilities;
computing a whisker maximum based on the interquartile range and an upper median of the range of event-type probabilities;
computing a whisker minimum based on the interquartile range and a lower median of the range of event-type probabilities;
tagging the important event type as having atypically high run-time event-type probability in response to the run-time event-type probability being greater than the whisker maximum; and
tagging the important event type as having atypically low run-time event-type probability in response to the run-time event-type probability being less than the whisker maximum.

14. The system of claim 8 wherein determining which of the important event types occur in a run-time interval are potential root causes of the performance problem comprises;
determining the probabilities of the important events in the run-time interval;
determining which of the important event types occur in a run-time interval with an atypically high probability or an atypical low probability; and
tagging the important event types with the atypically high probability or the atypical low probability as being the most likely root cause of the performance problem.

15. A non-transitory computer-readable medium having instructions encoded thereon for enabling one or more processors of a computer system to perform operations comprising:
using machine learning to train an inference model that relates event types recorded in metrics, log messages, and traces of the application over a historical time period to values of a key performance indicator (“KPI”) of the application recorded in the historical time period;
using the trained inference model to determine which of the event types are important event types that relate to performance of the application based on probabilities of the event types occurring in the historical time period;
in response to detecting a run-time performance problem in the KPI, determining which of the important event types occur in a run-time interval are potential root causes of the performance problem based on probabilities of the important even types occurring in the run-time interval; and
displaying an alert that identifies the application as having the run-time performance problem, identity of the important event types that are potentially the root cause of the performance problem, and at least one recommendation for remedying the performance problem in a graphical user interface (“GUI”) of an electronic display device.

16. The medium of claim 15 wherein using machine learning to train the inference model comprises:
extracting event types from log messages recorded in the historical time window using regular expressions or Grok patterns;
computing divergence values based on the event types;
computing RED metrics for the traces of the application;
computing KPI values of the KPI in the historical time period based on one or more of the metrics;
compute event-type probabilities of event types of the metrics, divergence values, and RED metrics in historical time intervals of the historical time period; and
training the inference model based on the event-type probabilities.

17. The medium of claim 15 wherein using machine learning to train the inference model comprises:
for each historical time interval of the historical time period,
counting event types in each of the metrics divergence values, and
computing an event-type probability of the event type in the historical time interval based on the count of event type.

18. The medium of claim 15 wherein using machine learning to train the inference model comprises:
training a parametric inference model based on probabilities of event types in historical time intervals of the historical time period;
a cross-validation error estimate of the parametric inference model; and
computing a non-parametric inference model in response to the cross-validation error estimate being greater than a cross validation threshold.

19. The medium of claim 15 wherein using the trained inference model to determine which of the event types are important event types comprises:
for each event type,
forming event-type distributions that exclude event-type probabilities of the event type,
computing an estimated provisional KPI for the event type based on the event-type distributions that exclude the event-type probabilities of the event type,
computing a mean square error (“MSE”) between the estimated provisional KPI and the KPI, and
computing an estimated standard error between the estimated provisional KPI and the KPI;
determining a maximum MSE from MSE between estimated provisional KPIs and the KPI;
computing a relative importance score for each of the event types based on the estimated standard error of the event types and the maximum MSE; and
designating event types with relative importance scores that are greater than a score threshold as important event types.

20. The medium of claim 15 wherein determining which of the important event types occur in the run-time interval comprises for each important event type:
computing a run-time event-type probability for the importance event type based on a count of the number of times the important event type occurs in the run-time interval;
computing medians that partition a range of event-type probabilities of the important into quartiles;
computing an interquartile range for the range of event-type probabilities;
computing a whisker maximum based on the interquartile range and an upper median of the range of event-type probabilities;
computing a whisker minimum based on the interquartile range and a lower median of the range of event-type probabilities;
tagging the important event type as having atypically high run-time event-type probability in response to the run-time event-type probability being greater than the whisker maximum; and
tagging the important event type as having atypically low run-time event-type probability in response to the run-time event-type probability being less than the whisker maximum.

21. The medium of claim 15 wherein determining which of the important event types occur in a run-time interval are potential root causes of the performance problem comprises:
determining the probabilities of the important events in the run-time interval;
determining which of the important event types occur in a run-time interval with an atypically high probability or an atypical low probability; and
tagging the important event types with the atypically high probability or the atypical low probability as being the most likely root cause of the performance problem.
